(19) United States
(12) Patent Application Publication
(10) Pub. No.: US 2022/0012313 A1
(43) Pub. Date: Jan. 13, 2022

(54) IN-VEHICLE INFORMATION APPARATUS AND METHOD OF COOPERATING WITH MOBILE TERMINAL

(71) Applicant: MITSUBISHI ELECTRIC CORPORATION, Tokyo (JP)

(72) Inventors: Tadashi MIYAHARA, Tokyo (JP); Mitsuo SHIMOTANI, Tokyo (JP)

(73) Assignee: MITSUBISHI ELECTRIC CORPORATION, Tokyo (JP)

(21) Appl. No.: 17/052,238

(22) PCT Filed: Aug. 2, 2018
(86) PCT No.: PCT/JP2018/028997

§ 371 Date: Nov. 2, 2020

(51) Int. Cl. G06F 21/31; H04W 4/48; G06K 9/00; G06F 3/0481; G06F 3/0482; G06F 3/0488

(52) U.S. Cl. CPC G06F 21/31; H04W 4/48; G06F 3/04883; G06F 3/04817; G06F 3/0482; G06K 9/00845

(57) ABSTRACT

A preliminary operation detector in an in-vehicle information apparatus detects a preliminary operation of an operation performed by a passenger of a vehicle on a screen of a display, the screen being installed in the vehicle. An operator identifier identifies, as an operator, the passenger who has performed the preliminary operation. The controller identifies a mobile terminal of the operator, and displays, on the screen, a cooperation start icon corresponding to the mobile terminal of the operator. A controller starts a cooperative operation with the mobile terminal of the operator when an operation detector detects an operation performed by the operator on the cooperation start icon.

### TECHNICAL FIELD

The present invention relates to an in-vehicle information apparatus that can perform a cooperative operation with a mobile terminal.

### BACKGROUND ART

In-vehicle information apparatuses that can perform a cooperative operation with a mobile terminal of a passenger (occupant) of a vehicle are known. For example, in a mirroring system, an execution screen of application software (hereinafter referred to as an “app”) running on a mobile terminal is displayed on a screen of an in-vehicle information apparatus. Moreover, the app is teleoperated using the in-vehicle information apparatus to appear as if the app runs on the in-vehicle information apparatus.

Furthermore, Patent Document 1 below discloses an in-vehicle information apparatus co-operable with mobile terminals of a plurality of passengers. The in-vehicle information apparatus of Patent Document 1 prestores information in which seat positions of the passengers are associated with IDs of mobile terminals of the passengers. Identifying the seat of the passenger owning the cooperating mobile terminal enables the execution of a process corresponding to the seat position of the passenger.

### PRIOR ART DOCUMENT

### Patent Document

[Patent Document 1] Japanese Patent Application Laid-Open No. 2017-19400

### SUMMARY

### Problem to be Solved by the Invention

An operator of the in-vehicle information apparatus co-operable with mobile terminals of a plurality of passengers needs to select a mobile terminal that cooperates with the in-vehicle information apparatus. Thus, a technology for supporting the selection is desired. Furthermore, it is necessary to prevent the operator from selecting a mobile terminal of another passenger without permission to protect privacy and in view of the security.

The present invention has been conceived to solve the problems, and has an object of providing an in-vehicle information apparatus that supports the operator for selecting a mobile terminal that cooperates with the in-vehicle information apparatus and that can prevent the operator from selecting the mobile terminal of the other passenger without permission.

### Means to Solve the Problem

An in-vehicle information apparatus according to the present invention includes: a communication unit to communicate for performing a cooperative operation with a mobile terminal; a passenger information storage in which passenger information is stored, the passenger information including information that can identify a passenger of a vehicle; a mobile terminal information storage in which mobile terminal information is stored, the mobile terminal information including information in which the passenger of the vehicle is associated with the mobile terminal of the passenger; an operation detector to detect an operation performed by the passenger of the vehicle on a screen of a display, the screen being installed in the vehicle; a preliminary operation detector to detect a preliminary operation of the operation performed by the passenger of the vehicle on the screen; an operator identifier to identify, as an operator based on the passenger information, the passenger who has performed the preliminary operation; and a controller to identify the mobile terminal of the operator based on the mobile terminal information when the operator identifier identifies the operator, display, on the screen, a cooperation start icon corresponding to the mobile terminal of the operator, and start the cooperative operation with the mobile terminal of the operator when an operation performed by the operator on the cooperation start icon is detected.

### Effects of the Invention

Since the in-vehicle information apparatus according to the present invention identifies an operator from a preliminary operation of an operation on a screen and displays a cooperation start icon corresponding to a mobile terminal of the operator on the screen, the operator can more promptly and easily select its own mobile terminal than by actually operating the screen to select the mobile terminal. Furthermore, the in-vehicle information apparatus identifies the operator, so that selection of a mobile terminal of a passenger other than the operator without permission can be prevented.

The objects, features, aspects and advantages of the present invention will become more apparent from the following detailed description and the accompanying drawings.

### BRIEF DESCRIPTION OF DRAWINGS

FIG. 1 is a block diagram illustrating a configuration of an in-vehicle information system according to Embodiment 1.

FIG. 2 illustrates an example arrangement of seats and a screen of a display in a vehicle.

FIG. 3 illustrates operations of an operation detector and a preliminary operation detector.

FIG. 4 illustrates an example initial screen to be displayed by an in-vehicle information apparatus on the screen of the display.

FIG. 5 illustrates an example cooperation start icon.

FIG. 6 illustrates an example function selection menu of a mobile terminal.

FIG. 7 illustrates an example detailed menu of functions of a mobile terminal.

FIG. 8 is a flowchart illustrating operations of the in-vehicle information apparatus according to Embodiment 1.

FIG. 9 illustrates an example hardware configuration of the in-vehicle information apparatus.

FIG. 10 illustrates an example hardware configuration of the in-vehicle information apparatus.

FIG. 11 illustrates an example of a cooperation start icon and function selection icons of the in-vehicle information apparatus.

FIG. 12 illustrates an example cooperation start icon.

FIG. 13 illustrates an example cooperation start icon.

FIG. 14 illustrates an example cooperation start icon.

FIG. 15 illustrates an example cooperation start icon.

FIG. 16 illustrates an example cooperation start icon.

FIG. 17 illustrates an example cooperation start icon.

FIG. 18 illustrates example cooperation start icons.

FIG. 19 illustrates example cooperation start icons.

FIG. 20 illustrates an example operation screen of the in-vehicle information apparatus.

FIG. 21 illustrates an example operation screen of the in-vehicle information apparatus.

FIG. 22 illustrates a plurality of example cooperation start icons.

FIG. 23 illustrates a plurality of example cooperation start icons.

FIG. 24 illustrates a plurality of example cooperation start icons.

FIG. 25 illustrates an example arrangement of seats and screens of a plurality of displays in a vehicle.

FIG. 26 is a block diagram illustrating a configuration of an in-vehicle information system according to Embodiment 2.

FIG. 27 illustrates an example arrangement of seats, screens of displays, and an in-vehicle camera in a vehicle.

FIG. 28 is an example image captured by the in-vehicle camera.

FIG. 29 is a block diagram illustrating a configuration of an in-vehicle information system according to Embodiment 3.

FIG. 30 is a block diagram illustrating a configuration of an in-vehicle information system according to Embodiment 4.

FIG. 31 illustrates an example arrangement of seats, a screen of a display, and in-vehicle microphones in a vehicle.

FIG. 32 is a block diagram illustrating a configuration of an in-vehicle information system according to Embodiment 5.

FIG. 33 illustrates an authentication data obtaining device and a passenger authenticator.

FIG. 34 is a flowchart illustrating operations of the in-vehicle information apparatus according to Embodiment 5.

FIG. 35 is a flowchart illustrating an authentication/registration process.

FIG. 36 is a flowchart illustrating an initial operation determining process.

FIG. 37 is a flowchart illustrating a history updating process.

FIG. 38 illustrates an example in-vehicle agent.

FIG. 39 illustrates an example in-vehicle agent.

FIG. 40 illustrates an example in-vehicle agent.

FIG. 41 illustrates an example in-vehicle agent.

FIG. 42 illustrates an example input screen for configuration information of a mobile terminal.

### DESCRIPTION OF EMBODIMENTS

### Embodiment 1

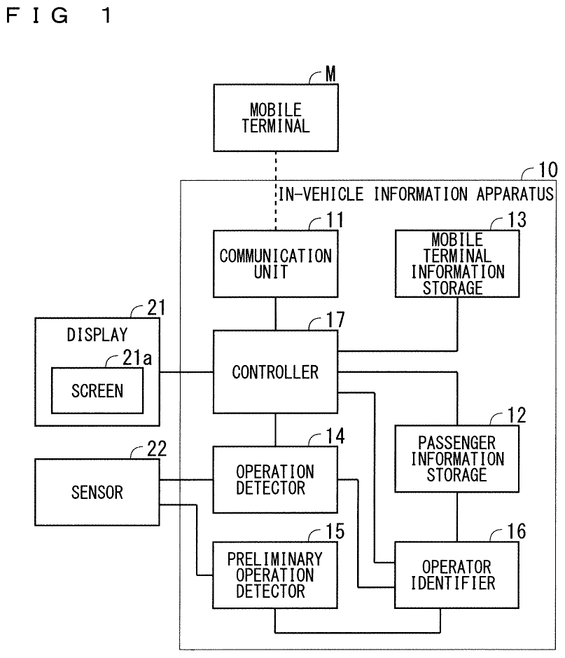

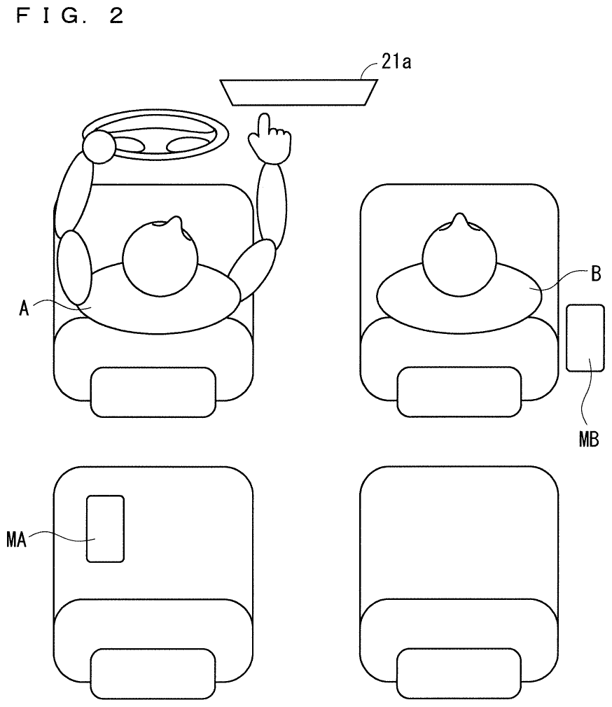

FIG. 1 is a block diagram illustrating a configuration of an in-vehicle information system according to Embodiment 1 of the present invention. As illustrated in FIG. 1, the in-vehicle information system according to Embodiment 1 includes an in-vehicle information apparatus 10 mounted on a vehicle, and a display 21 and a sensor 22 that are connected to the in-vehicle information apparatus 10. Furthermore, the in-vehicle information apparatus 10 can perform a cooperative operation with a mobile terminal M owned by a passenger of the vehicle. Although the number of the mobile terminals M is only one in FIG. 1, each passenger sometimes carries the mobile terminal M co-operable with the in-vehicle information apparatus 10, for example, as illustrated in FIG. 2. In the example of FIG. 2, a mobile terminal MA of a passenger A and a mobile terminal MB of a passenger B are brought to the vehicle as the mobile terminals M.

The display 21 is, for example, a liquid crystal display, and includes a screen 21a installed in the vehicle. As illustrated in FIG. 2, the screen 21a is placed in a position operable by a plurality of passengers, for example, as a center panel of the vehicle.

The sensor 22 is a sensor that detects a position of an indicator for operating the screen 21a of the display 21. It is assumed in Embodiment 1 that the indicator is the passenger's finger. The sensor 22 includes a touch sensor that detects a position of the finger that touches the surface of the screen 21a, and a space sensor that detects a position of the finger in the space around the screen 21a. Since there is no constraint on the types of the space sensors, for example, an infrared sensor, a capacitive sensor, a time-of-flight (ToF) sensor, or an image sensor (a camera) is available.

As illustrated in FIG. 1, the in-vehicle information apparatus 10 includes a communication unit 11, a passenger information storage 12, a mobile terminal information storage 13, an operation detector 14, a preliminary operation detector 15, an operator identifier 16, and a controller 17.

The communication unit 11 is a communication means for the in-vehicle information apparatus 10 to perform external communication. The in-vehicle information apparatus 10 communicates through the communication unit 11 for performing a cooperative operation with the mobile terminal M.

The passenger information storage 12 is a storage medium for storing passenger information that is information on a passenger of the vehicle. The passenger information includes information that can identify the passenger of the vehicle. The passenger information according to Embodiment 1 need not be information that can identify an individual passenger (e.g., fingerprint information, iris information, or face information), but should be at least information that can identify on which seat each passenger is seated. The passenger information according to Embodiment 1 is information on the seat position of each passenger.

The mobile terminal information storage 13 is a storage medium for storing mobile terminal information that is information on the mobile terminal M co-operable with the in-vehicle information apparatus 10. The mobile terminal information includes information in which a passenger is associated with the mobile terminal M of the passenger. In other words, the mobile terminal information includes information that can identify on which seat of a passenger is the owner of the mobile terminal M.

It is assumed in Embodiment 1 that each passenger enters, into the in-vehicle information apparatus 10 in advance (e.g., in boarding of the passenger), information on the seat position of the passenger and information in which the passenger is associated with the mobile terminal M owned by the passenger so that these pieces of information are registered in the passenger information storage 12 and the mobile terminal information storage 13.

The operation detector 14 detects an operation performed by the passenger on the screen 21a of the display 21, based on a detection result of the position of the passenger's finger using the sensor 22. Furthermore, the preliminary operation detector 15 detects an operation performed by the passenger on the screen 21a at a preliminary step (hereinafter referred to as a “preliminary operation”), based on the detection result of the position of the passenger's finger using the sensor 22. In Embodiment 1, a touch operation performed by bringing the finger into contact with the screen 21a is defined as an operation on the screen 21a, whereas an operation of moving the finger close to the screen 21a for performing the touch operation is defined as a preliminary operation of the touch operation. In other words, the operation detector 14 detects a touch operation on the screen 21a, whereas the preliminary operation detector 15 detects the movement of the finger approaching the screen 21a according to Embodiment 1.

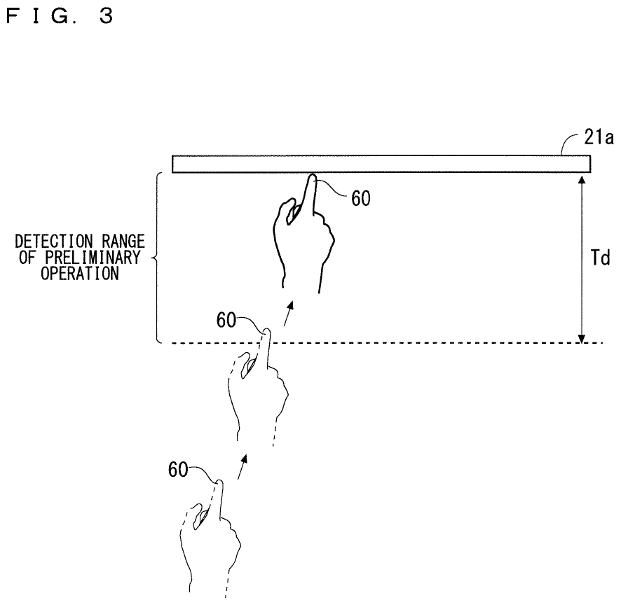

For example, when the passenger moves the finger 60 close to the screen 21a to touch the screen 21a as illustrated in FIG. 3, the preliminary operation detector 15 detects, as a preliminary operation of an operation, the movement of the finger 60 from when a distance between the finger 60 and the screen 21a is smaller than a predefined threshold Td until the finger 60 reaches the screen 21a. In other words, the space where the distance from the screen 21a is smaller than the Td is a detection range of the preliminary operation. Furthermore, the operation detector 14 detects a position (coordinates) at which the finger 60 comes into contact on the screen 21a.

The operator identifier 16 determines the passenger who has performed the preliminary operation detected by the preliminary operation detector 15, based on the passenger information stored in the passenger information storage 12, and identifies the passenger as the operator. The operator identifier 16 according to Embodiment 1 identifies on which seat the passenger who has performed the preliminary operation is seated, that is, the passenger on which seat is the operator. For example, when the screen 21a is installed as the center panel of the vehicle, the operator is a passenger on the driver seat (a driver) or a passenger on the assistant driver seat as illustrated in FIG. 2. Furthermore, the operator identifier 16 can determine whether the operator is on the driver seat or the assistant driver seat, depending on from which side, the driver seat side or the assistant driver seat side, the passenger's finger that has performed the preliminary operation approaches the screen 21a.

The controller 17 controls various operations of the in-vehicle information apparatus 10 including execution of an app running on the in-vehicle information apparatus 10 and cooperation with the mobile terminal M. Particularly, when the passenger of the vehicle performs a preliminary operation of an operation on the screen 21a and the operator identifier 16 identifies the operator, the controller 17 identifies the mobile terminal M of the operator based on the mobile terminal information (information in which a passenger is associated with the mobile terminal M) stored in the mobile terminal information storage 13, and displays a “cooperation start icon” corresponding to the mobile terminal M of the operator on the screen 21a. When the operation detector 14 detects an operation on the cooperation start icon performed by the operator on the screen 21a, the controller 17 starts a cooperative operation with the mobile terminal M of the operator.

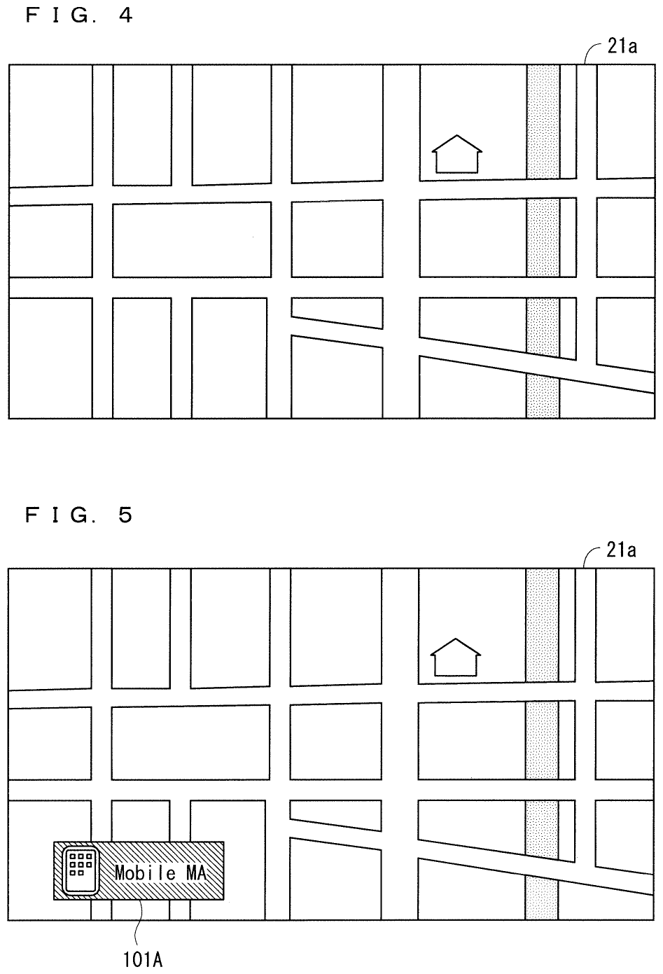

It is assumed herein that the in-vehicle information apparatus 10 is a navigation apparatus and that the controller 17 executes a map app to display a map as illustrated in FIG. 4 on the screen 21a in a normal operation (when a cooperative operation with the mobile terminal M is not performed). In other words, the map displayed on the screen 21a of FIG. 4 is generated by the app running on the in-vehicle information apparatus 10. Hereinafter, the app running on the in-vehicle information apparatus 10 will be referred to as an “in-vehicle app”, and the app running on the mobile terminal M will be referred to as a “mobile app”.

When the passenger of the vehicle brings the finger into contact with the screen 21a from the state in FIG. 4, the preliminary operation detector 15 detects the movement of the finger as a preliminary operation of an operation, and the operator identifier 16 identifies the passenger who has performed the preliminary operation as the operator. Then, the controller 17 identifies the mobile terminal M of the operator, and displays, on the screen 21a, the cooperation start icon corresponding to the mobile terminal M of the operator. For example, when the operator identifier 16 identifies the passenger A on the driver seat as the operator, the controller 17 displays, on the screen 21a, a cooperation start icon 101A corresponding to the mobile terminal MA (Mobile MA) of the passenger A as illustrated in FIG. 5.

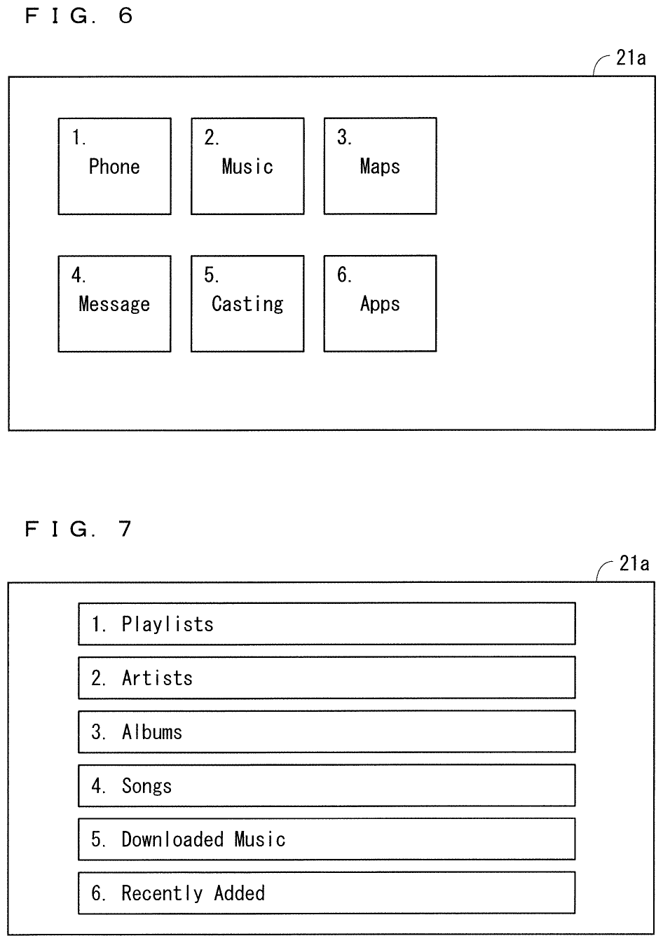

Then, when the operator touches the cooperation start icon on the screen 21a with the finger, the operation detector 14 detects the movement of the finger as an operation of the cooperation start icon, and the controller 17 starts a cooperative operation with the mobile terminal M of the operator. For example, when the operator touches the cooperation start icon 101A in FIG. 5, the controller 17 starts a cooperative operation with the mobile terminal MA, and displays, on the screen 21a, a function selection menu (a list of executable apps) of the mobile terminal MA as illustrated in FIG. 6. Then, when the operator touches a “Music” icon in the function selection menu in FIG. 6, a music app of the mobile terminal MA is launched, and a detailed menu of the music app (a play list of tunes herein) is displayed as illustrated in FIG. 7. In other words, the menus displayed on the screen 21a in FIGS. 6 and 7 are generated by the mobile app running on the mobile terminal MA.

As such, while the in-vehicle information apparatus 10 and the mobile terminal M perform the cooperative operation, the operator can operate the mobile app running on the mobile terminal M by operating an operation screen of the mobile app displayed on the screen 21a. Thereby, the operator can operate the mobile app in the similar sense as operating the in-vehicle app.

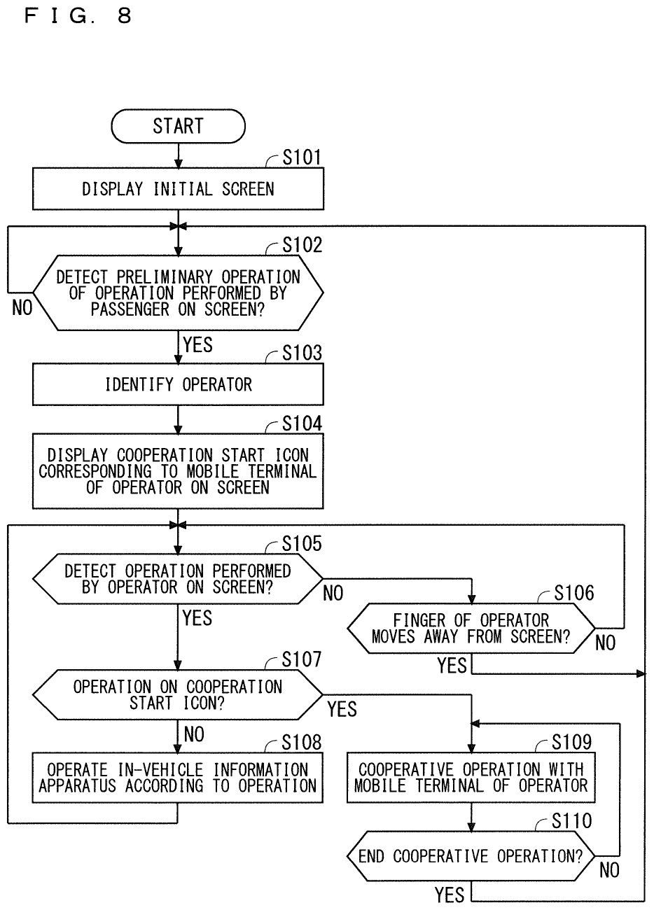

FIG. 8 is a flowchart illustrating operations of the in-vehicle information apparatus 10. The operations of the in-vehicle information apparatus 10 will be described with reference to FIG. 8.

Once the in-vehicle information apparatus 10 is started, the controller 17 displays a predefined initial screen on the screen 21a of the display 21 (Step S101). The initial screen may be any. For example, when the in-vehicle information apparatus 10 is a navigation apparatus, the initial screen may be a display screen of the map as illustrated in FIG. 4.

Next, the controller 17 checks whether the preliminary operation detector 15 has detected a preliminary operation of an operation performed by the passenger on the screen 21a (Step S102). If the preliminary operation of the operation on the screen 21a is not detected (NO in Step S102), Step S102 is repeated.

If the preliminary operation of the operation on the screen 21a is detected (YES in Step S102), the operator identifier 16 identifies the passenger who has performed the preliminary operation as the operator (Step S103). Then, the controller 17 identifies the mobile terminal M of the operator based on the mobile terminal information (information in which the passenger is associated with the mobile terminal M) stored in the mobile terminal information storage 13, and displays the cooperation start icon corresponding to the mobile terminal M of the operator on the screen 21a (Step S104).

Then, the controller 17 checks whether the operation detector 14 has detected the operation performed by the operator on the screen 21a (Step S105). If the operation performed by the operator on the screen 21a is not detected (NO in Step S105), the preliminary operation detector 15 checks whether the finger of the operator moves away from the screen 21a, specifically, whether the finger leaves the detection range of the preliminary operation (see FIG. 3) (Step S106). If the finger of the operator moves away from the screen 21a (YES in Step S106), the processes return to Step S102. If not (NO in Step S106), the processes return to Step S105.

If the operation detector 14 detects the operation performed by the operator on the screen 21a (YES in Step S105), the controller 17 checks whether the operation is an operation on the cooperation start icon (Step S107). If the operation is not the operation on the cooperation start icon (NO in Step S107), the controller 17 operates the in-vehicle information apparatus 10 according to the operation (e.g., execution of the in-vehicle app) (Step S108), and returns to Step S105.

If the operation detected by the operation detector 14 is the operation on the cooperation start icon (YES in Step S107), the controller 17 performs a cooperative operation with the mobile terminal M of the operator (Step S109). During the cooperative operation with the mobile terminal M (NO in Step S110), the operation screen of the mobile app running on the mobile terminal M is displayed on the screen 21a. The operator can operate the mobile app in the similar sense as operating the in-vehicle app by operating the operation screen. When the cooperative operation with the mobile terminal M ends (YES in Step S110), the processes return to Step S102.

To protect privacy and in view of the security, the operator of the operation screen of the mobile app displayed on the screen 21a should be restricted to the owner of the mobile terminal M, that is, only the operator who has operated the cooperation start icon during the cooperative operation with the mobile terminal M. Which passenger has operated the operation screen of the mobile app displayed on the screen 21a can be determined in the same method as that for determining the operator. In other words, the preliminary operation detector 15 detects the preliminary operation of the operation of the passenger, and the operator identifier 16 determines who the passenger (the passenger on which seat) is, based on the movement of the passenger's finger. Thereby, it is possible to determine which passenger has performed the subsequent operations.

As described above, the in-vehicle information apparatus 10 according to Embodiment 1 identifies an operator from the preliminary operation of the operation performed by the passenger on the screen 21a, and displays, on the screen 21a, the cooperation start icon corresponding to the mobile terminal M of the operator. Before the operator actually operates the screen 21a, the targets of the cooperative operation are narrowed down to the mobile terminal M of the operator. Thus, the operator can promptly and easily make its own mobile terminal M cooperate with the in-vehicle information apparatus 10. Furthermore, the in-vehicle information apparatus 10 identifies the mobile terminal M of the operator. Thus, it is possible to prevent the mobile terminal M of another passenger from becoming the target of the cooperative operation without permission.

[Example Hardware Configuration]

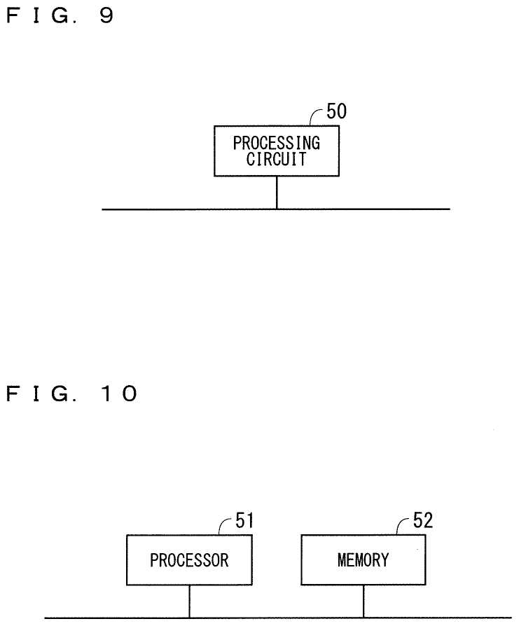

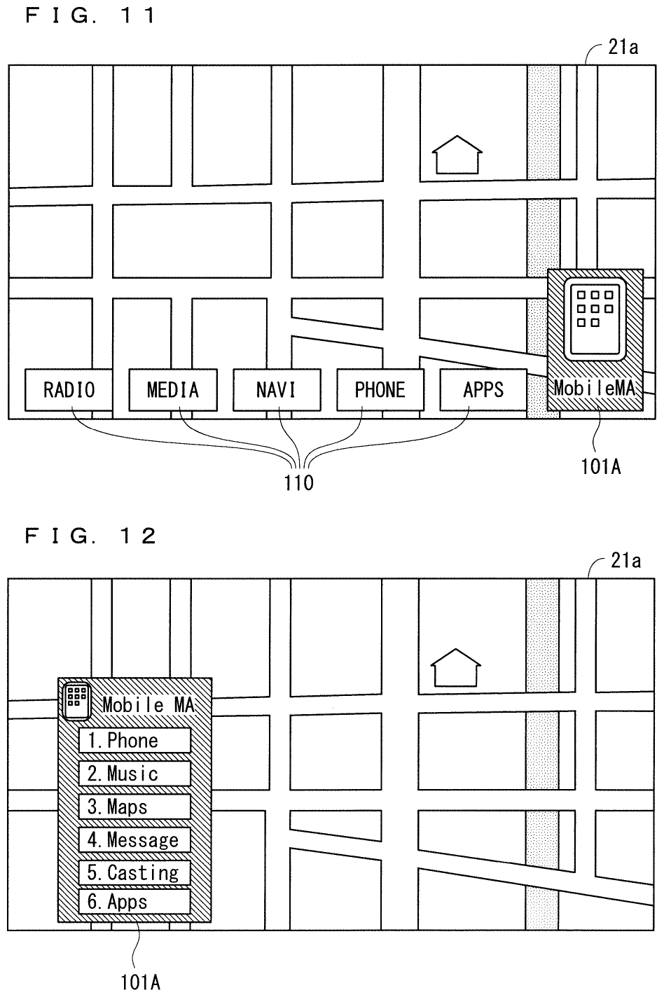

Each of FIGS. 9 and 10 illustrates an example hardware configuration of the in-vehicle information apparatus 10. Each function of the constituent elements of the in-vehicle information apparatus 10 illustrated in FIG. 1 is implemented by, for example, a processing circuit 50 illustrated in FIG. 9. In other words, the in-vehicle information apparatus 10 includes the processing circuit 50 for: detecting a preliminary operation of an operation performed by a passenger of a vehicle on the screen 21a of the display 21, the screen 21a being installed in the vehicle; identifying, as an operator, the passenger who has performed the preliminary operation; identifying a mobile terminal of the operator, and displaying, on the screen 21a, a cooperation start icon corresponding to the mobile terminal of the operator; detecting an operation performed by the operator on the cooperation start icon; and starting a cooperative operation with the mobile terminal of the operator when the operation performed by the operator on the cooperation start icon is detected. The processing circuit 50 may be dedicated hardware or a processor (also referred to as a central processing unit (CPU), a processing unit, an arithmetic unit, a microprocessor, a microcomputer, or a digital signal processor (DSP)) which executes a program stored in a memory.

When the processing circuit 50 is dedicated hardware, examples of the processing circuit 50 include a single circuit, a composite circuit, a programmed processor, a parallel-programmed processor, an App Specific Integrated Circuit (ASIC), a Field-Programmable Gate Array (FPGA), and any combination of these. Each function of the constituent elements of the in-vehicle information apparatus 10 may be implemented by a separate processing circuit, or the functions may be collectively implemented by a single processing circuit.

FIG. 10 illustrates an example hardware configuration of the in-vehicle information apparatus 10 when the processing circuit 50 is a processor 51 that executes a program. Here, the functions of the constituent elements of the in-vehicle information apparatus 10 are implemented by, for example, software (software, firmware, or a combination of the software and the firmware). For example, the software is described as a program, and stored in a memory 52. The processor 51 performs the functions in each of the units by reading and executing the programs stored in the memory 52. In other words, the in-vehicle information apparatus 10 includes the memory 52 for storing a program which, when executed by the processor 51, consequently performs processes of: detecting a preliminary operation of an operation performed by a passenger of a vehicle on the screen 21a of the display 21, the screen 21a being installed in the vehicle; identifying, as an operator, the passenger who has performed the preliminary operation; identifying a mobile terminal of the operator, and displaying, on the screen 21a, a cooperation start icon corresponding to the mobile terminal of the operator; detecting an operation performed by the operator on the cooperation start icon; and starting a cooperative operation with the mobile terminal of the operator when the operation performed by the operator on the cooperation start icon is detected. Put it differently, this program causes a computer to execute procedures or methods of the operations of the constituent elements of the in-vehicle information apparatus 10.

Here, examples of the memory 52 may include non-volatile or volatile semiconductor memories such as a random-access memory (RAM), a read-only memory (ROM), a flash memory, an erasable programmable read-only memory (EPROM), an electrically erasable programmable read-only memory (EEPROM), a hard disk drive (HDD), a magnetic disc, a flexible disk, an optical disk, a compact disk, a mini disk, a Digital Versatile Disc (DVD), a drive device thereof, and further any a storage medium to be used in the future.

The configuration for implementing the functions of the constituent elements of the in-vehicle information apparatus 10 using one of the hardware and the software, etc., is described above. However, the configuration is not limited to this but a part of the constituent elements of the in-vehicle information apparatus 10 may be implemented by dedicated hardware, and another part of the constituent elements may be implemented by software, etc. For example, the processing circuit 50 functioning as the dedicated hardware can implement the functions of the part of the constituent elements, and the processing circuit 50 functioning as the processor 51 can implement the functions of the other part of the constituent elements through reading and executing a program stored in the memory 52.

As described above, the in-vehicle information apparatus 10 can implement each of the functions by hardware, software, etc., or any combinations of these.

[Modifications]

Some modifications of the in-vehicle information system according to Embodiment 1 will be hereinafter described. Unless particularly specified, it is assumed that the passenger A is identified as an operator in the following display examples of the cooperation start icon. The display examples of the cooperation start icon 101A corresponding to the mobile terminal MA (Mobile MA) of the passenger A will be described.

Although the operation detector 14 according to Embodiment 1 determines that the operation of touching the cooperation start icon has been performed when the operator touches the cooperation start icon on the screen 21a, it may regard that the touch operation has been performed when determining that the probability of performing the operation of touching the cooperation start icon is high, based on the movement of the finger of the operator. For example, the operation detector 14 may detect a distance between the cooperation start icon on the screen 21a and the finger of the operator, based on the output of the space sensor of the sensor 22, and regard that the operation of touching the cooperation start icon has been performed when the distance is smaller than or equal to a certain value. Furthermore, the operation detector 14 may detect the movement of the finger of the operator based on the output of the space sensor of the sensor 22, and regard that the operation of touching the cooperation start icon has been performed when detecting that the finger of the operator is moving toward the cooperation start icon.

Although the touch operation performed by bringing the finger into contact with the screen 21a is defined as an operation on the screen 21a according to Embodiment 1, for example, an air gesture operation without bringing the finger into contact with the screen 21a may be defined as an operation on the screen 21a. Here, when the operation detector 14 detects an air gesture operation performed by the operator on the cooperation start icon on the screen 21a, the controller 17 displays the cooperation start icon corresponding to the mobile terminal M of the operator on the screen 21a.

When all the operations on the screen 21a are performed using air gesture operations, the sensor 22 suffices to include a space sensor and thus need not always include a touch sensor. When an air gesture operation is defined as an operation on the screen 21a, the display 21 may be any displays that can be teleoperated, for example, a center display, a meter display, or a head-up display.

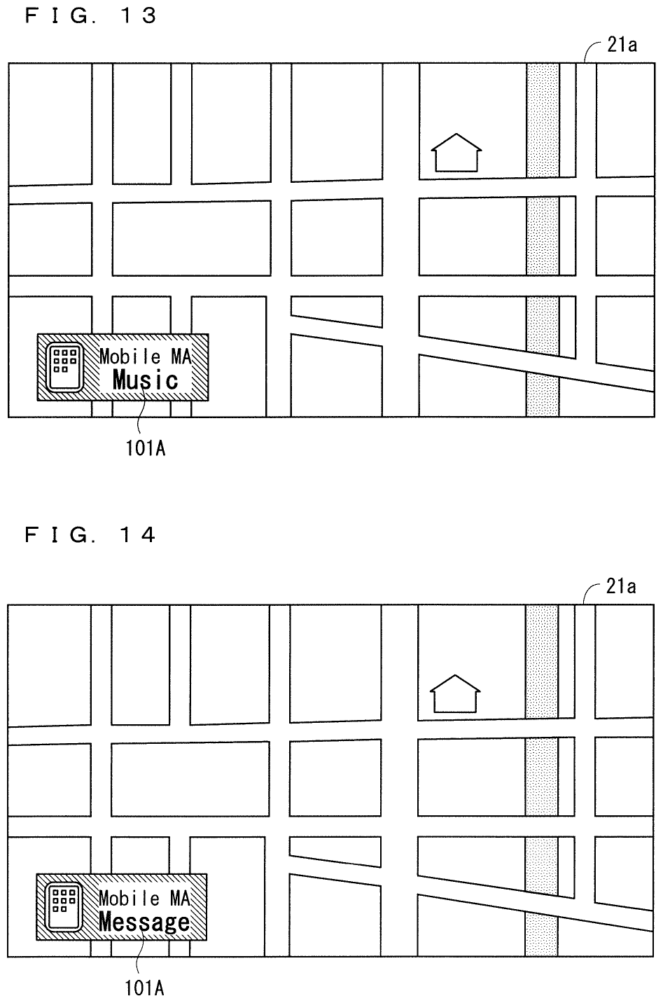

For example, what is known on a navigation apparatus that normally displays a map on the entire screen is a technology for overlaying an operation button on the map when a space sensor detects an approach of the user's hand to the screen. Since the in-vehicle information system according to Embodiment 1 includes the sensor 22 including the space sensor, the technology may be introduced. For example, assuming that the in-vehicle information apparatus 10 displays the map on the screen 21a in a normal operation as illustrated in FIG. 4, the preliminary operation detector 15 detects a preliminary operation of an operation performed by the passenger A on the screen 21a, and the operator identifier 16 identifies the passenger A as the operator. As illustrated in FIG. 11, the controller 17 may display, on the screen 21a, icons 110 of the operation buttons of the in-vehicle information apparatus 10 together with the cooperation start icon 101A corresponding to the mobile terminal MA of the passenger A.

The form of the cooperation start icon is not limited to those in FIGS. 5 and 11 but may be any. For example, as illustrated in FIG. 12, the cooperation start icon 101A corresponding to the mobile terminal MA may include a function selection menu of the mobile terminal MA. Here, when an operation on the function selection menu in the cooperation start icon 101A is performed, the controller 17 displays the detailed menu on the screen 21a as illustrated in FIG. 7. Specifically, a single operation on the cooperation start icon 101A can lead to an operation of causing the in-vehicle information apparatus 10 to start cooperation with the mobile terminal MA and an operation of selecting a function to be executed by the mobile terminal MA, thus improving the convenience.

The controller 17 may obtain an operation history of the mobile terminal M in the cooperative operation with the in-vehicle information apparatus 10, include the operation history in the mobile terminal information to store the operation history in the mobile terminal information storage 13, and reflect the operation history in the initial operation when performing the next cooperative operation with the same mobile terminal M. For example, the controller 17 may identify a function frequently used from the operation history of the mobile terminal M, and automatically start the function frequently used when starting the next cooperative operation with the same mobile terminal M. Alternatively, the controller 17 may identify a function last selected in the previous cooperative operation with the mobile terminal M, and automatically start the function last selected in the previous cooperative operation when starting the next cooperative operation with the same mobile terminal M. In such a case, the cooperation start icon 101A may include a symbol (text such as “Music” or “Message”) indicating a function to be launched when the cooperative operation is started, for example, as illustrated in FIG. 13 or 14.

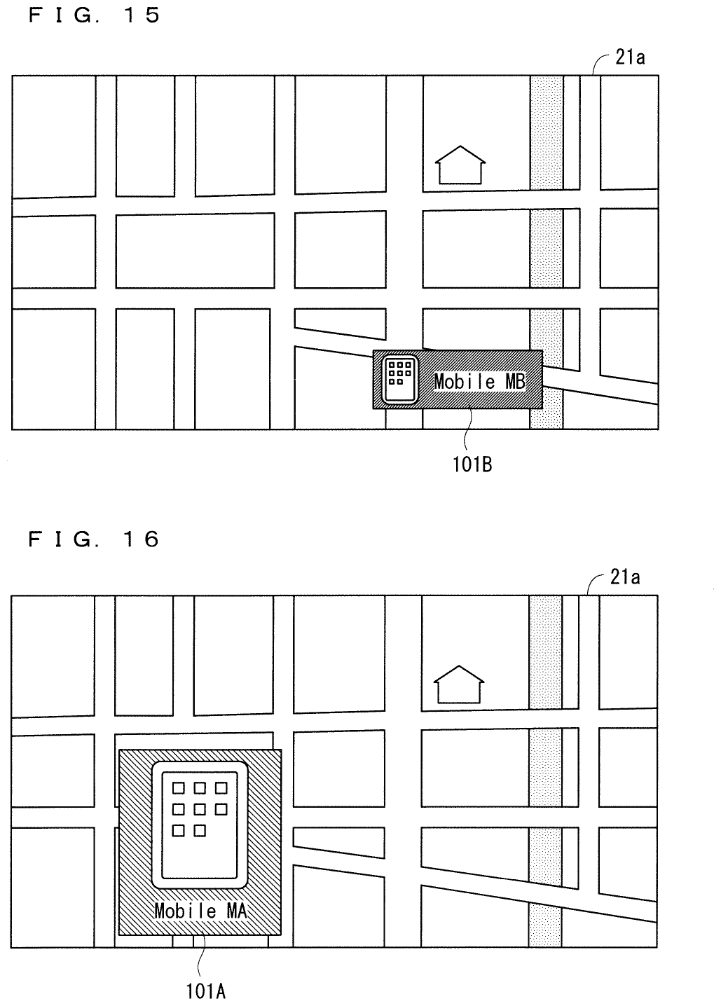

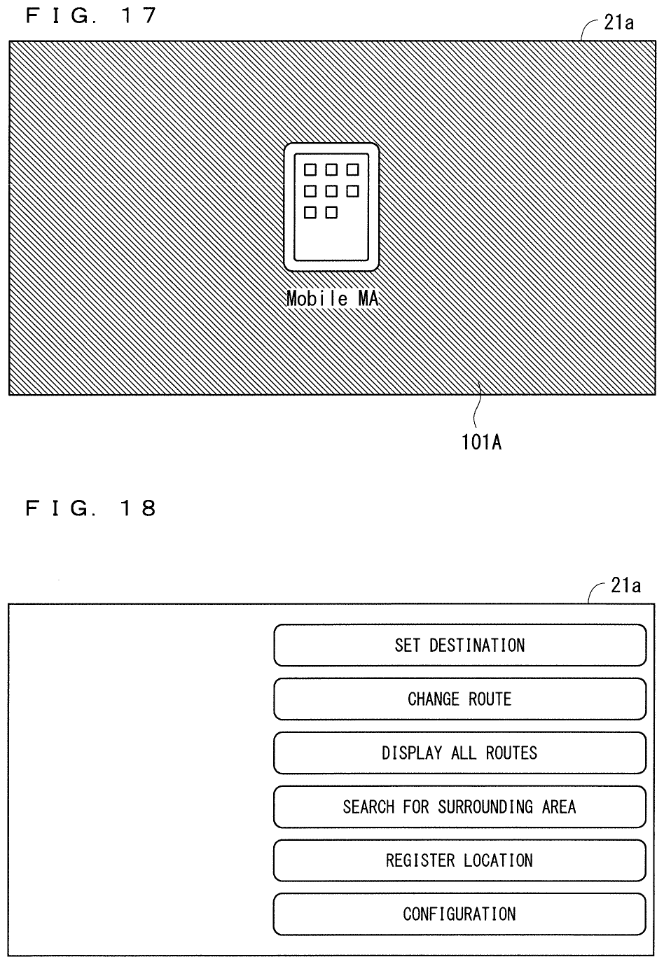

Furthermore, the controller 17 may change the form of the cooperation start icon, depending on whether the operator is a driver of the vehicle. Since it is difficult for the driver to operate the screen 21a while driving the vehicle and the timing at which the screen 21a can be operated is limited, the cooperation start icon corresponding to the mobile terminal M of the driver is preferably of a form that is easily viewed and operated. For example, a cooperation start icon 101B of a smaller size may be displayed when the operator is the passenger B on the assistant driver seat as illustrated in FIG. 15, whereas the cooperation start icon 101A of a larger size may be displayed when the operator is the passenger A on the driver seat as illustrated in FIG. 16. Furthermore, once detecting the approach of the finger of the passenger A on the driver seat to the cooperation start icon 101A from the state in FIG. 16, the controller 17 may display the cooperation start icon 101A on the entirety of the screen 21a as illustrated in FIG. 17, and start the cooperative operation between the mobile terminal MA of the passenger A and the in-vehicle information apparatus 10 wherever the passenger A touches on the screen 21a.

The timing at which the driver operates icons other than the cooperation start icon is also limited. Thus, the controller 17 may change the form of the various icons displayed on the screen during the cooperative operation with the mobile terminal M of the operator, depending on whether the operator is the driver. For example, in the function selection menu of the mobile terminal M displayed by the controller 17 on the screen 21a, function selection buttons of a smaller size may be displayed as illustrated in FIG. 18 if the owner of the mobile terminal M is not a driver, whereas function selection buttons of a larger size may be displayed as illustrated in FIG. 19 if the owner of the mobile terminal M is a driver. In the example of FIG. 19, the use of the function selection buttons with a design that represents the functions by marks allows the driver to intuitively recognize the functions corresponding to the respective buttons.

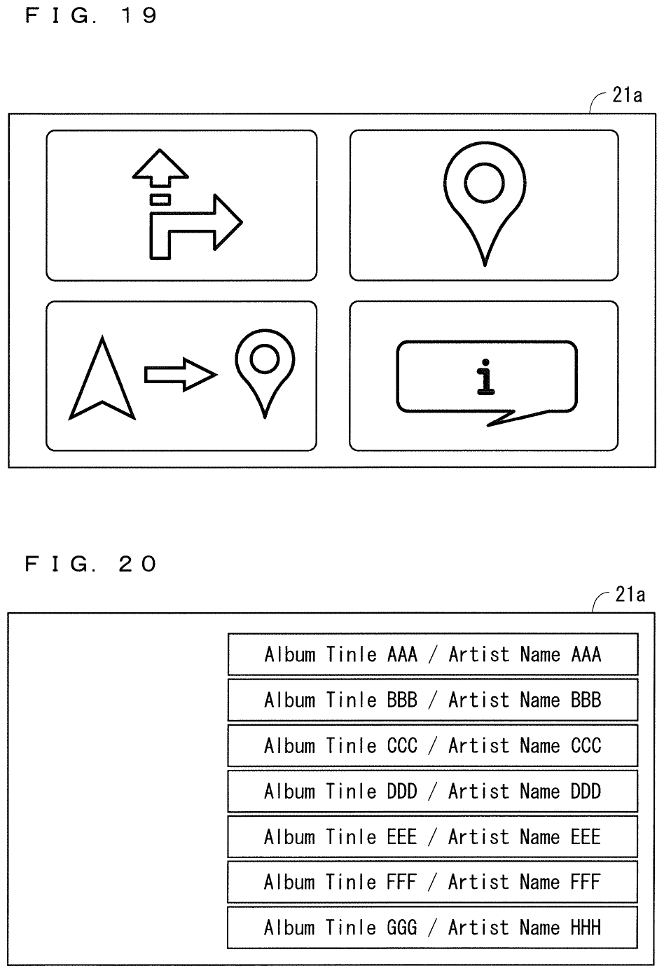

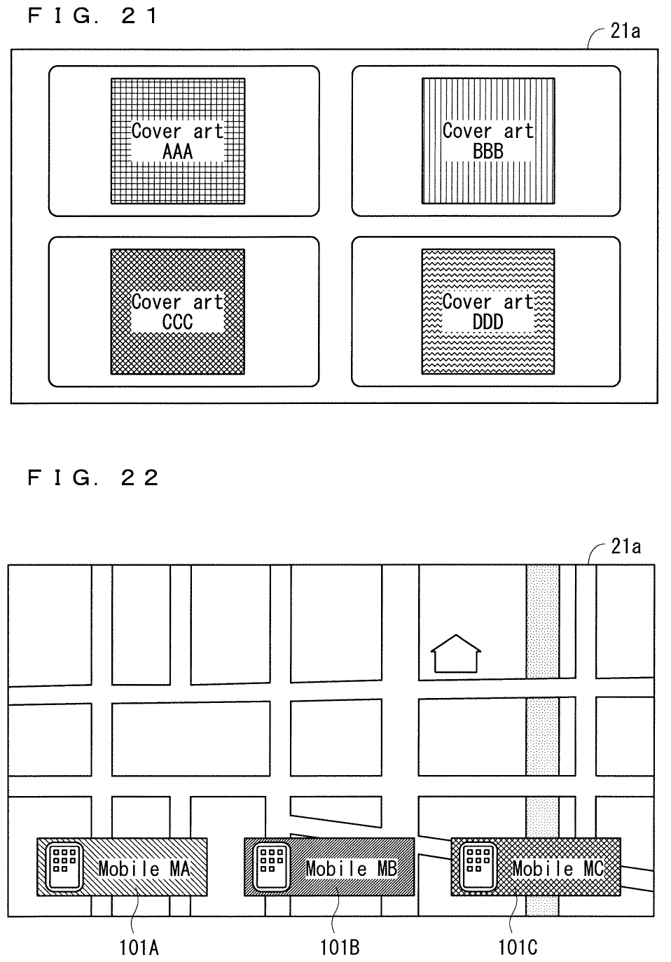

Furthermore, the controller 17 may also change the form of icons to be used in the detailed menu of the functions of the mobile terminal M to be displayed on the screen 21a, depending on whether the operator is a driver of the vehicle. For example, in a play list of the music app of the mobile terminal M to be displayed by the controller 17 on the screen 21a, tune selection buttons of a smaller size may be displayed as illustrated in FIG. 20 if the owner of the mobile terminal M is not a driver, whereas tune selection buttons of a larger size may be displayed as illustrated in FIG. 21 if the owner of the mobile terminal M is a driver. In the example of FIG. 21, the use of the tune selection buttons with a design that represents the tunes by cover art allows the driver to intuitively recognize the tunes corresponding to the respective buttons.

Furthermore, if the operator is a driver of the vehicle, the controller 17 may restrict launch of particular functions, the in-vehicle app, and the mobile app which may cause driver distraction.

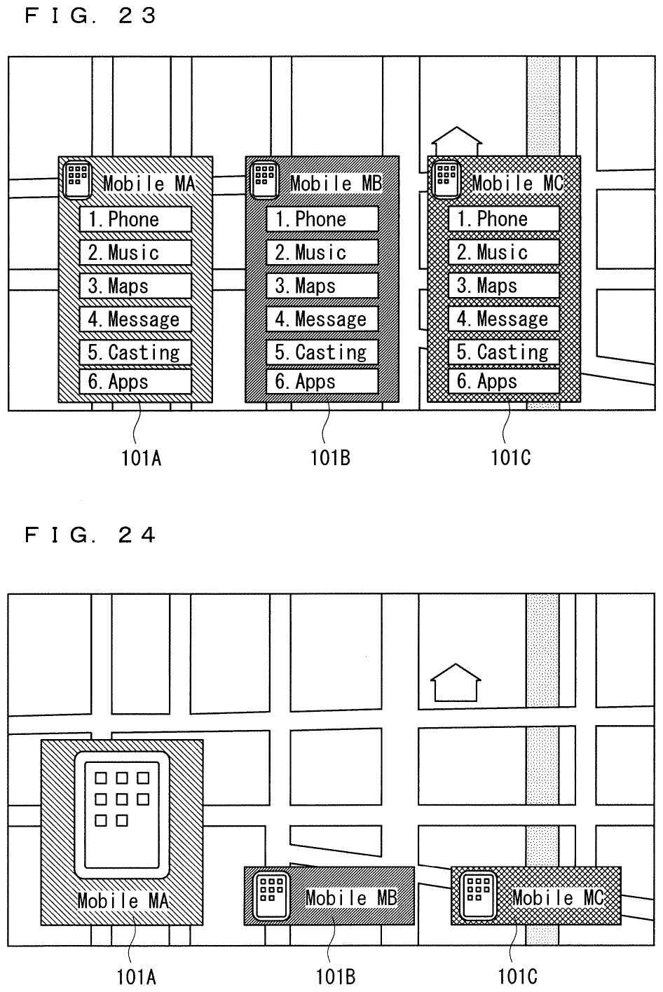

If the operator identifier 16 cannot identify a passenger as an operator, the controller 17 may display a plurality of cooperation start icons corresponding to a plurality of co-operable mobile terminals M on a screen to allow the passenger to select one of the mobile terminals M that will cooperate. For example, if three mobile terminals MA, MB, and MC co-operable with the in-vehicle information apparatus 10 exist in a vehicle, the controller 17 may display, on the screen 21a, the cooperation start icon 101A corresponding to the mobile terminal MA, the cooperation start icon 101B corresponding to the mobile terminal MB, and a cooperation start icon 101C corresponding to a mobile terminal MC as illustrated in FIG. 22. Here, when the operator operates the cooperation start icon 101A, the controller 17 starts the cooperative operation with the mobile terminal MA. When the operator operates the cooperation start icon 101B, the controller 17 starts the cooperative operation with the mobile terminal MB. When the operator operates the cooperation start icon 101C, the controller 17 starts the cooperative operation with the mobile terminal MC. With application of the modification illustrated in FIG. 12, the cooperation start icons 101A, 101B, and 101C may include function selection menus of the mobile terminals MA, MB, and MC, respectively, as illustrated in FIG. 23.

Furthermore, even if the operator identifier 16 can identify a passenger as an operator, the controller 17 may display, in a different form from that of the cooperation start icon 101A on the screen 21a, the cooperation start icons 101B and 101C corresponding to the other co-operable mobile terminals MB and MC together with the cooperation start icon 101A corresponding to the mobile terminal MA of the operator, as illustrated in FIG. 24. Similarly, when the operator operates the cooperation start icon 101A, the controller 17 starts the cooperative operation with the mobile terminal MA. When the operator operates the cooperation start icon 101B, the controller 17 starts the cooperative operation with the mobile terminal MB. When the operator operates the cooperation start icon 101C, the controller 17 starts the cooperative operation with the mobile terminal MC.

When the operator selects the mobile terminal M that will cooperate similarly to the examples of FIGS. 22 to 24, it is necessary to prevent the operator from selecting the mobile terminals M of the other passengers without permission. Thus, only if the in-vehicle information apparatus 10 performs personal authentication (details of the personal authentication will be described in Embodiments below) of the passenger who has operated the cooperation start icon and determines the passenger as the owner of the selected mobile terminal M, it is preferred that the in-vehicle information apparatus 10 starts the cooperative operation with the selected mobile terminal M.

Even if the passenger who has operated a cooperation start icon is not the owner of the mobile terminal M corresponding to the cooperation start icon, if permission is received from the owner of the mobile terminal M, the controller 17 may cause the mobile terminal M to cooperate with the in-vehicle information apparatus 10. Examples of a method for the owner of the mobile terminal M to give permission to the in-vehicle information apparatus 10 include input of permission through an operation on the screen 21a, input of permission through an operation on the mobile terminal M, and voice input of permission using a voice input apparatus (not illustrated). It is preferred herein that the in-vehicle information apparatus 10 performs personal authentication of the passenger who has entered the permission to check if the passenger is the true owner of the mobile terminal M.

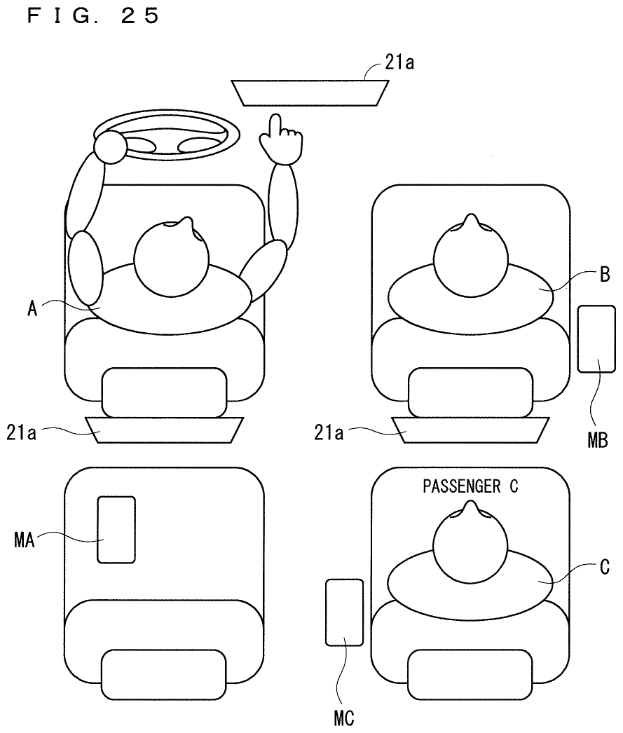

Furthermore, when the cooperation between the in-vehicle information apparatus 10 and the mobile terminal M other than that of the operator is permitted as the modification illustrated in FIG. 24, a plurality of in-vehicle information systems may be introduced into the vehicle, and the screens 21a of the in-vehicle information systems may be installed for the respective seats as illustrated in FIG. 25. This can build a system in which each of the passengers can teleoperate their mobile terminal M using the screen 21a for each seat.

The menu illustrated in FIG. 6 or 7 may include a “return icon” for returning to the screen in a normal operation as illustrated in FIG. 4. The operator can return the display of the screen 21a to the screen in the normal operation by touching the return icon or moving the finger close to the return icon. Without any operation on the screen 21a for a certain period of time while the menu illustrated in FIG. 6 or 7 is displayed on the screen 21a, the display of the screen 21a may be returned to the screen in the normal operation.

### Embodiment 2

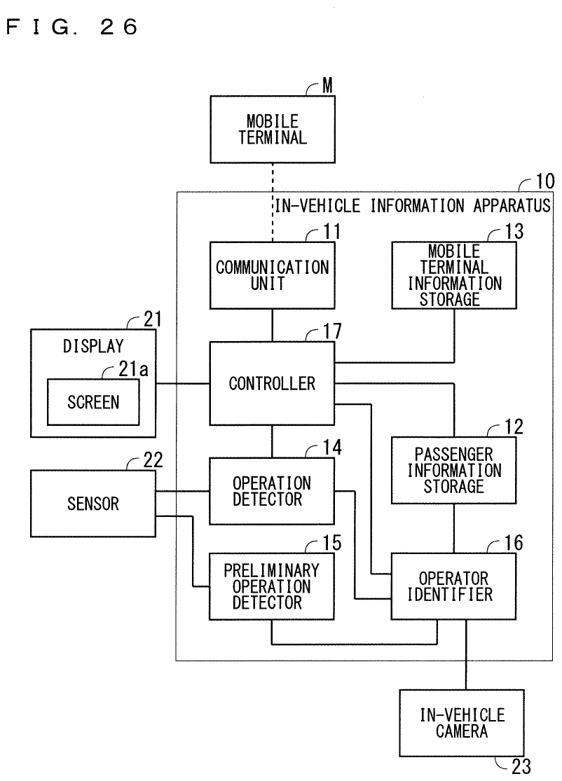

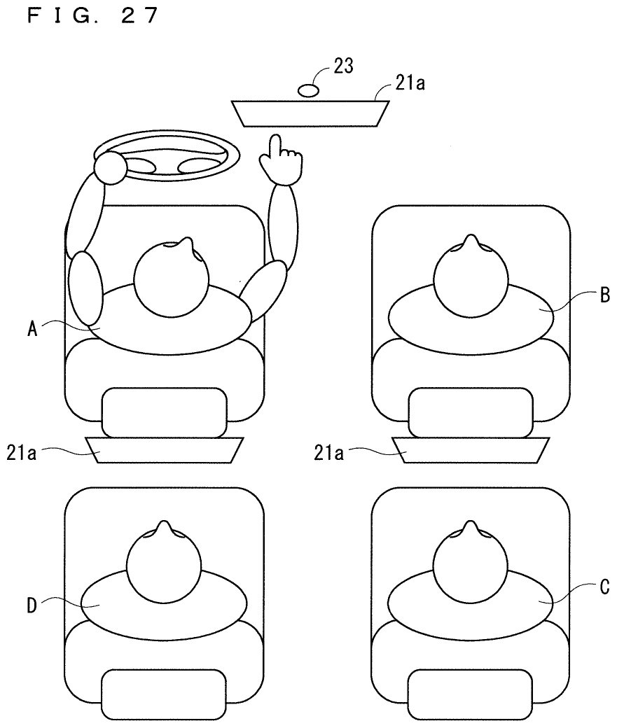

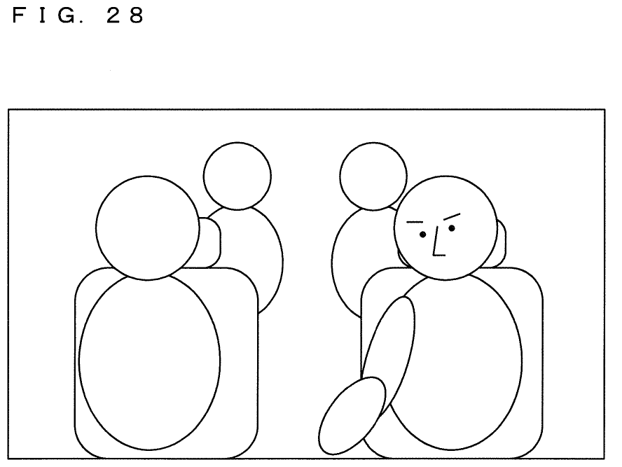

FIG. 26 is a block diagram illustrating a configuration of an in-vehicle information system according to Embodiment 2 of the present invention. The configuration of the in-vehicle information system in FIG. 26 is obtained by further connecting an in-vehicle camera 23 to the in-vehicle information apparatus 10 in the configuration of FIG. 1. As illustrated in FIG. 27, the in-vehicle camera 23 is disposed near the screen 21a to capture an image of a passenger who performs an operation or a preliminary operation thereof on the screen 21a. FIG. 28 is an example image captured by the in-vehicle camera 23.

The operator identifier 16 according to Embodiment 2 determines on which seat the passenger who has performed the preliminary operation of the operation on the screen 21a is seated by analyzing the image captured by the in-vehicle camera 23, and identifies the passenger on the seat as the operator. For example, when the preliminary operation detector 15 detects the preliminary operation of the operation on the screen 21a in a vehicle where the driver seat is on the left side as illustrated in FIG. 27, in the case where an image showing that the passenger on the right side when viewed from the in-vehicle camera 23 reaches for the screen 21a is captured as illustrated in FIG. 28, the operator identifier 16 identifies the passenger on the driver seat as the operator.

The operator identifier 16 identifies the operator by analyzing the image captured by the in-vehicle camera 23, which can improve the precision of identifying the operator more than that of identifying the operator based on the movement of the passenger's finger detected by the sensor 22.

### Embodiment 3

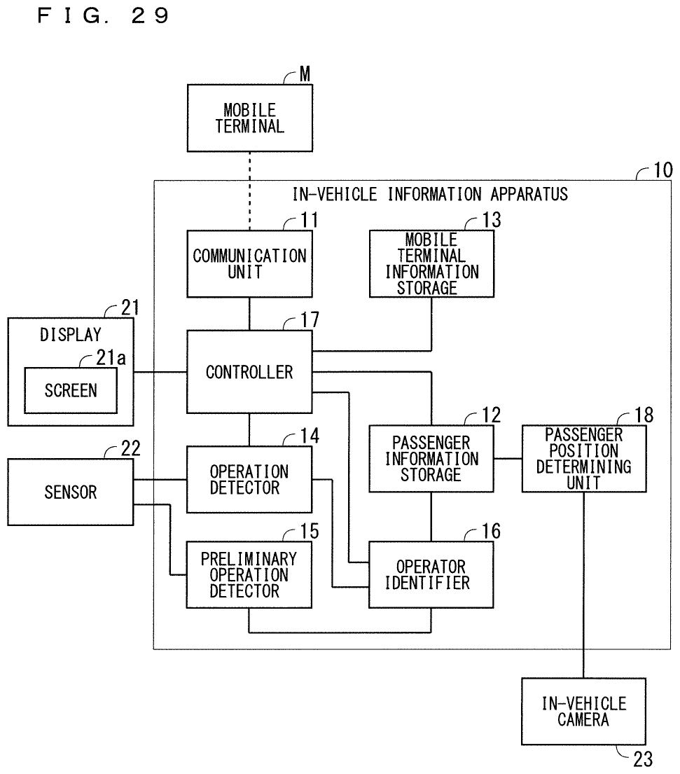

FIG. 29 is a block diagram illustrating a configuration of an in-vehicle information system according to Embodiment 3 of the present invention. The configuration of the in-vehicle information system in FIG. 29 is obtained by adding a passenger position determining unit 18 to the in-vehicle information apparatus 10 as well as further connecting the in-vehicle camera 23 to the in-vehicle information apparatus 10 in the configuration of FIG. 1. Similarly to Embodiment 2, the in-vehicle camera 23 is disposed near the screen 21a to capture an image of a passenger on each seat.

Although the passenger enters, into the in-vehicle information apparatus 10, information on the seat position of each passenger to be registered in the passenger information storage 12 according to Embodiment 1, the passenger position determining unit 18 according to Embodiment 3 determines the seat position of each passenger by analyzing the image captured by the in-vehicle camera 23, and registers the determination result in the passenger information storage 12. Specifically, the passenger position determining unit 18 performs person identification of the passenger on each seat by analyzing the image captured by the in-vehicle camera 23 to determine who the passenger on each seat is. The biological information on the passenger, which is required for the person identification through the image analysis, for example, face information or iris information is prestored in the passenger information storage 12 as the passenger information.

Since the operator identifier 16 automatically registers information on the seat position of each passenger in the passenger information storage 12 according to Embodiment 3, the passenger need not input the information, and is provided with more convenience.

Embodiment 3 may be combined with Embodiment 2. Specifically, when the image captured by the in-vehicle camera 23 in FIG. 29 is also entered into the operator identifier 16 and the preliminary operation detector 15 detects a preliminary operation of an operation performed by the passenger on the screen 21a, the operator identifier 16 may identify the operator by analyzing the image.

### Embodiment 4

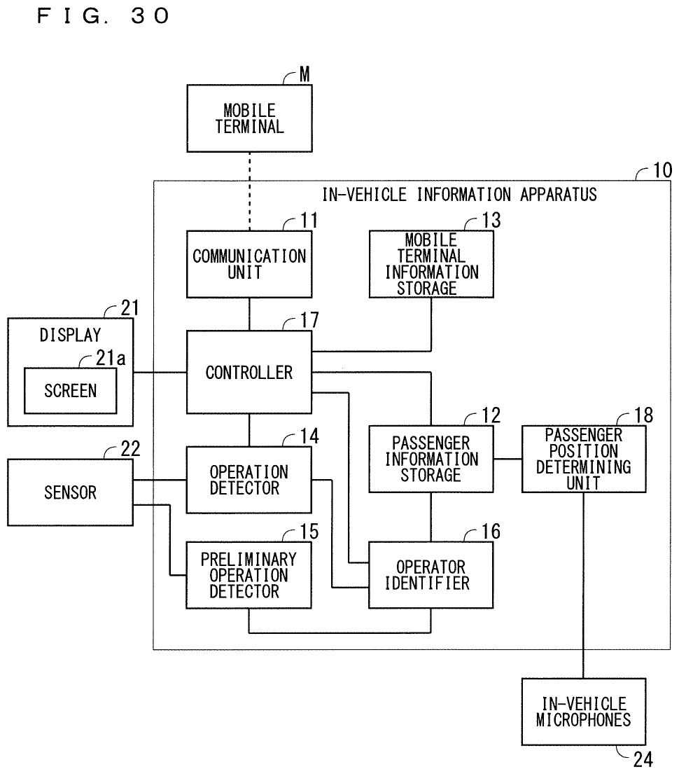

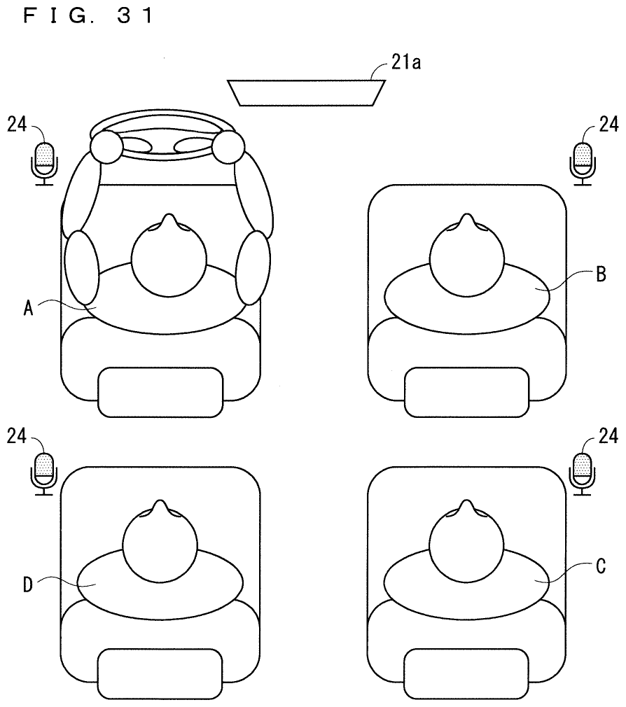

FIG. 30 is a block diagram illustrating a configuration of an in-vehicle information system according to Embodiment 4 of the present invention. The configuration in FIG. 30 is obtained by adding the passenger position determining unit 18 to the in-vehicle information apparatus 10 as well as further connecting in-vehicle microphones 24 to the in-vehicle information apparatus 10 in the configuration of FIG. 1. As illustrated in FIG. 31, the in-vehicle microphone 24 is disposed near each seat of the vehicle to obtain the voice uttered by the passenger on the seat.

The passenger position determining unit 18 according to Embodiment 4 determines the seat position of each passenger by analyzing the voice of the passenger on the seat which is obtained by the in-vehicle microphone 24, and registers the determination result in the passenger information storage 12. Specifically, the passenger position determining unit 18 performs person identification of the passenger on each seat by analyzing the voice obtained by the in-vehicle microphone 24 to determine who the passenger on the seat is. Voice print information, which is the biological information on the passenger and is required for the person identification through the voice analysis, is prestored in the passenger information storage 12 as the passenger information.

Since the operator identifier 16 automatically registers information on the seat position of each passenger in the passenger information storage 12 according to Embodiment 4 similarly to Embodiment 3, the passenger need not input the information, and is provided with more convenience.

### Embodiment 5

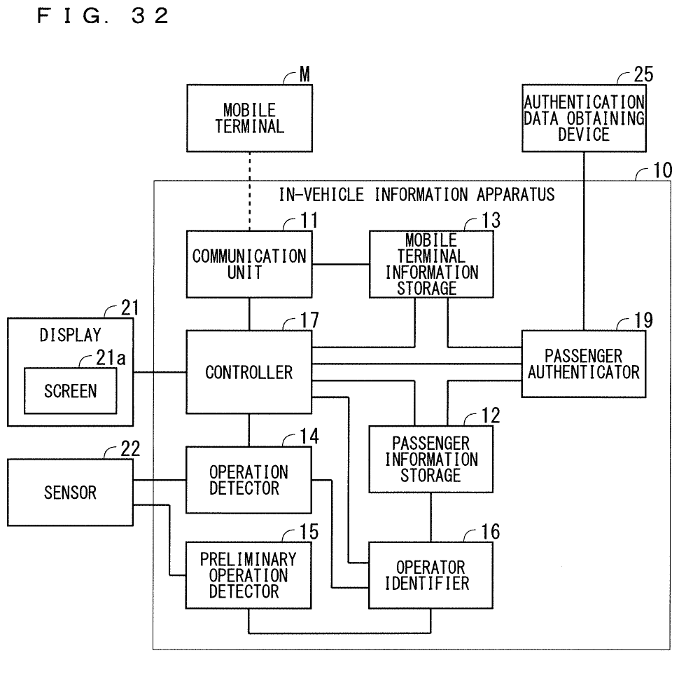

FIG. 32 is a block diagram illustrating a configuration of an in-vehicle information system according to Embodiment 5 of the present invention. The configuration in FIG. 32 is obtained by adding a passenger authenticator 19 to the in-vehicle information apparatus 10 as well as further connecting an authentication data obtaining device 25 to the in-vehicle information apparatus 10 in the configuration of FIG. 1.

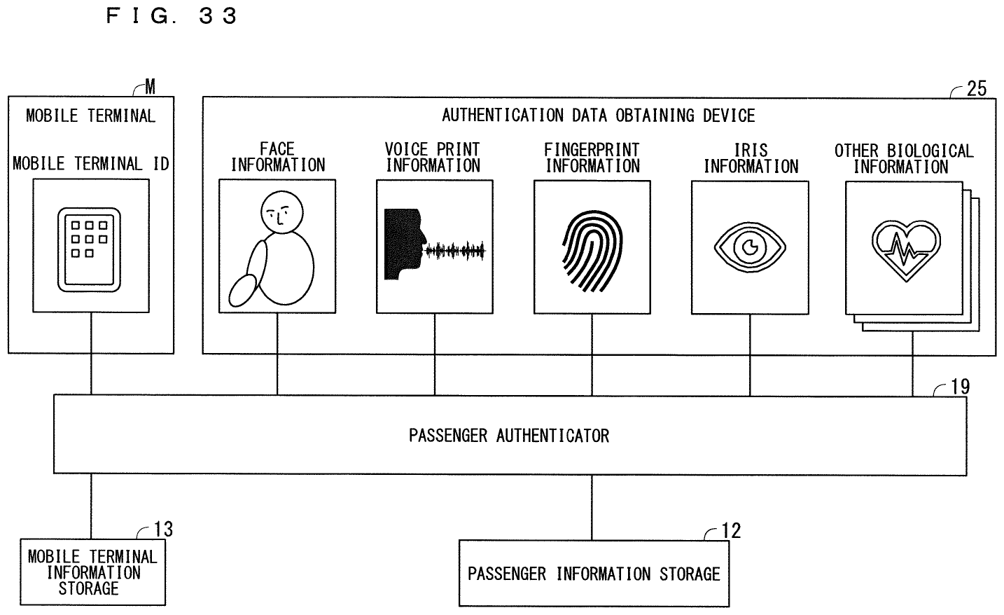

FIG. 33 illustrates the authentication data obtaining device 25 and the passenger authenticator 19. The authentication data obtaining device 25 is, for example, a camera, a microphone, or a fingerprint scanner for obtaining authentication data for performing personal authentication of the passenger, e.g., biological information including face information, voice print information, fingerprint information, and iris information. In Embodiment 5, personal information (the biological information including face information, voice print information, fingerprint information, and iris information) that is check data to be used for performing personal authentication of the passenger is prestored in the passenger information storage 12 as the passenger information.

The passenger authenticator 19 checks the authentication data of the passenger obtained by the authentication data obtaining device 25 against the check data of the passenger which is stored in the passenger information storage 12 to perform personal authentication of the passenger. Furthermore, the passenger authenticator 19 also checks the ID of the mobile terminal M that the passenger brought to the vehicle against the ID of the mobile terminal M associated with the passenger, based on the mobile terminal information stored in the mobile terminal information storage 13 to check whether the passenger does not use the mobile terminals of the others without authorization.

The service provider of the vehicle (e.g., a car manufacturer, a car dealer, or a carsharing service vendor) can configure the type of the personal information that the passenger authenticator 19 uses for performing personal authentication, in consideration of, for example, security, the convenience, and the cost. Accordingly, the service provider of the vehicle can establish the security and the convenience that are optimal for their own service the most cost-effectively.

Furthermore, configuration information for each passenger which is associated with the operation of the in-vehicle information apparatus 10 is stored in the passenger information storage 12 as the passenger information. Examples of the configuration information probably include name, gender, age, birthday, home address, and office address of the passenger, the location where the passenger frequents, a favorite music genre, a favorite artist, a favorite broadcaster, configuration of a function selection menu of the mobile terminal, and information on whether to cooperate with another cloud service. The controller 17 reflects these pieces of configuration information in the cooperative operation with the mobile terminal M of the passenger.

Particularly, preference information indicating the preference of the passenger such as the location where the passenger frequents, a favorite music genre, a favorite artist, or a favorite broadcaster may be used for determining an initial operation to be performed upon start of the cooperation with the mobile terminal M of the passenger. For example, when starting the cooperation with the mobile terminal M of the passenger, the controller 17 may display information on the location where the passenger frequents, or start playing back the favorite music of the passenger. Furthermore, the configuration information of each passenger may be editable using the mobile terminal M of the passenger accepted by the personal authentication performed by the passenger authenticator 19.

Furthermore, the mobile terminal information stored in the mobile terminal information storage 13 according to Embodiment 5 includes information on the operation history of the mobile terminal M in the past cooperative operation, and information on the reaction history of the passenger who has reacted as the operator to the initial operation in the past cooperative operation. The reaction history of the operator is a history of expressions and operations of the operator when the initial operation in the cooperative operation has been performed. For example, when the operator has an annoyed expression or performs an operation of changing the initial operation to another operation upon start of the initial operation, it is possible to determine that the initial operation has been inappropriate (undesirable for the operator).

The controller 17 determines the initial operation in the cooperative operation with the mobile terminal M of the operator, based on the operation history of the mobile terminal M of the operator and the reaction history of the operator. For example, when identifying a function frequently used and less frequently determined as an inappropriate function in the past from the operation history of the mobile terminal M and the reaction history of the operator and starting the next cooperative operation with the same mobile terminal M, the controller 17 may automatically start the identified function.

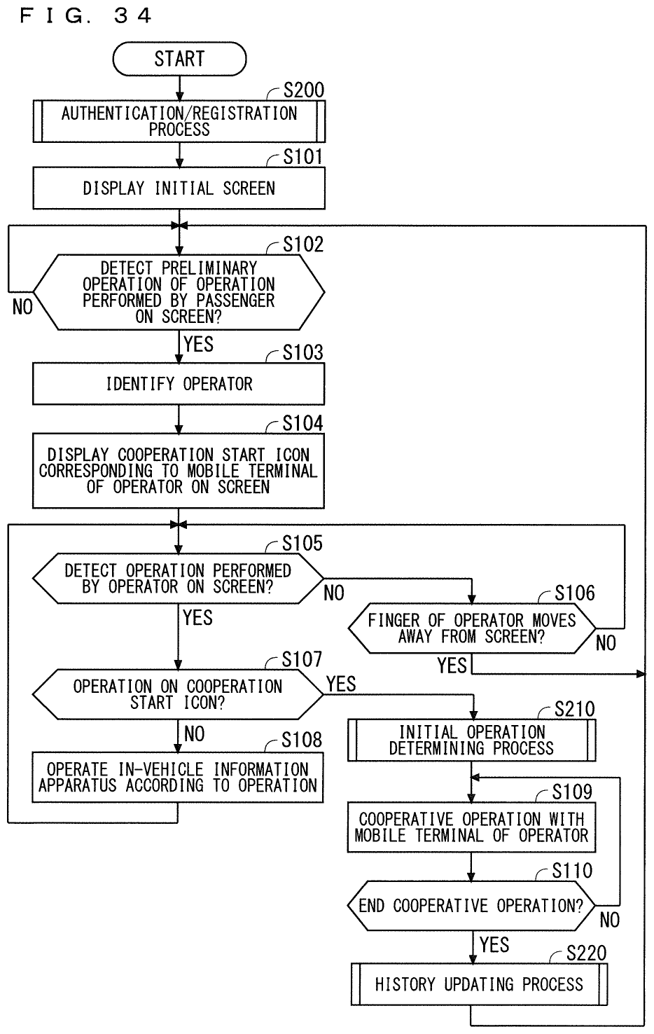

FIG. 34 is a flowchart illustrating operations of the in-vehicle information apparatus 10 according to Embodiment 5. The flowchart of FIG. 34 is obtained by adding Steps S200, S210, and S220 described below to the flowchart of FIG. 8.

Step S200 is executed when the in-vehicle information apparatus 10 is started. In Step S200, personal authentication of each passenger in a vehicle is performed, and a new passenger is registered. The process in Step S200 is referred to as an “authentication/registration process”.

Step S210 is executed before the cooperative operation with the mobile terminal M of the operator is started (before Step S109). In Step S210, the initial operation to be performed when the cooperative operation is started is determined. The process in Step S210 is referred to as an “initial operation determining process”.

Step S220 is executed after the cooperative operation with the mobile terminal M of the operator ends (after YES in Step S110). In Step S220, the operation history of the mobile terminal M and the reaction history of the passenger that are stored in the mobile terminal information storage 13 are updated, based on the reaction of the operator when the cooperative operation with the mobile terminal M has been started and on the operations of the operator performed during the cooperative operation. The process in Step S220 is referred to as a “history updating process”.

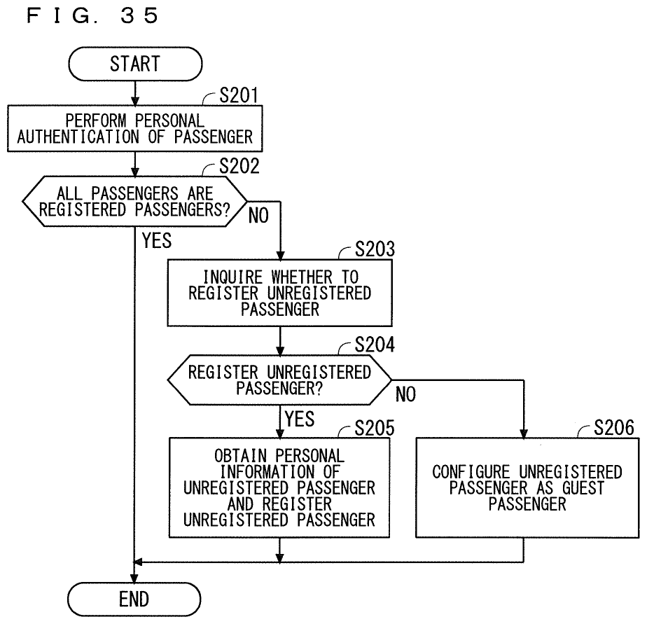

FIGS. 35, 36, and 37 are flowcharts illustrating the authentication/registration process, the initial operation determining process, and the history updating process, respectively. The operations of the in-vehicle information apparatus 10 according to Embodiment 5 will be described with reference to FIGS. 34 to 37.

Once the in-vehicle information apparatus 10 is started, the authentication/registration process in FIG. 35 is performed (Step S200). In the authentication/registration process, first, the passenger authenticator 19 performs personal authentication of each passenger in the vehicle (Step S201). The controller 17 determines whether all the passengers are passengers registered in the in-vehicle information apparatus 10 (hereinafter referred to as “registered passengers”), based on the result of the personal authentication (Step S202). When all the passengers are registered passengers (YES in Step S202), the authentication/registration process ends.

If a passenger who is not yet registered (hereinafter referred to as an “unregistered passenger”) such as a passenger who boards the vehicle for the first time is present (NO in Step S202), the controller 17 inquires of the current passenger whether to register the unregistered passenger in the in-vehicle information apparatus 10 (Step S203). If the current passenger responds that the unregistered passenger is to be registered (YES in Step S204), the in-vehicle information apparatus 10 obtains the personal information (the biological information such as face information, voice print information, fingerprint information, and iris information) of the unregistered passenger as check data, and the configuration information of the passenger, register the unregistered passenger as a registered passenger (Step S205), and ends the authentication/registration process. The in-vehicle information apparatus 10 may obtain the personal information of the passenger using a camera or a fingerprint scanner of the authentication data obtaining device 25 or by transferring, to the in-vehicle information apparatus 10, the personal information prestored by the passenger in the mobile terminal M.

If the current passenger responds that the unregistered passenger is not registered (NO in Step S204), the in-vehicle information apparatus 10 configures the unregistered passenger as a guest passenger (Step S206), and ends the authentication/registration process.

Referring back to FIG. 34, after the authentication/registration process (Step S200) ends, the controller 17 displays the predefined initial screen on the screen 21a of the display 21 (Step S101).

Next, the controller 17 checks whether the preliminary operation detector 15 has detected a preliminary operation of the operation performed by the passenger on the screen 21a (Step S102). If the preliminary operation of the operation on the screen 21a is not detected (NO in Step S102), Step S102 is repeated.

If the preliminary operation of the operation on the screen 21a is detected (YES in Step S102), the operator identifier 16 identifies the passenger who has performed the preliminary operation as the operator (Step S103). Then, the controller 17 identifies the mobile terminal M of the operator based on the mobile terminal information (information in which the passenger is associated with the mobile terminal M) stored in the mobile terminal information storage 13, and displays the cooperation start icon corresponding to the mobile terminal M of the operator on the screen 21a (Step S104).

Then, the controller 17 checks whether the operation detector 14 has detected the operation performed by the operator on the screen 21a (Step S105). If the operation performed by the operator on the screen 21a is not detected (NO in Step S105), the preliminary operation detector 15 checks whether the finger of the operator moves away from the screen 21a, specifically, whether the finger leaves the detection range of the preliminary operation (see FIG. 3) (Step S106). If the finger of the operator moves away from the screen 21a (YES in Step S106), the processes return to Step S102. If not (NO in Step S106), the processes return to Step S105.

If the operation detector 14 detects the operation performed by the operator on the screen 21a (YES in Step S105), the controller 17 checks whether the operation is the operation on the cooperation start icon (Step S107). If the operation is not the operation on the cooperation start icon (NO in Step S107), the controller 17 operates the in-vehicle information apparatus 10 according to the operation (e.g., execution of the in-vehicle app) (Step S108), and returns to Step S105.

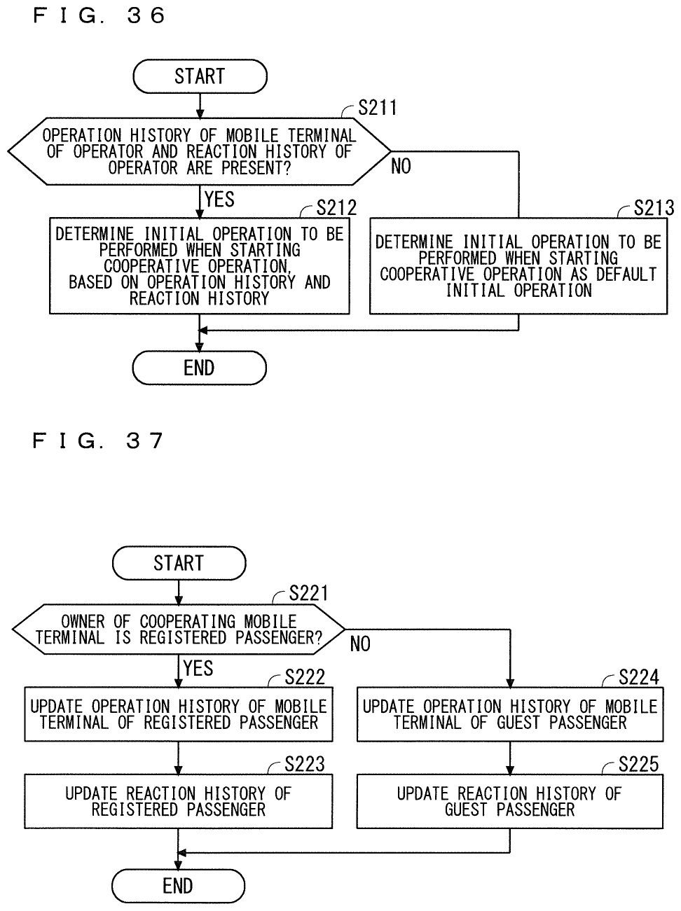

If the operation detected by the operation detector 14 is the operation on the cooperation start icon (YES in Step S107), the initial operation determining process illustrated in FIG. 36 is performed (Step S210). In the initial operation determining process, first, the controller 17 checks whether the operation history of the mobile terminal M of the operator and the reaction history of the operator are present with reference to the passenger information of the operator which is stored in the passenger information storage 12 (Step S211).

If the operation history and the reaction history are present (YES in Step S211), the controller 17 determines the initial operation to be performed when starting the cooperative operation with the mobile terminal M of the operator, based on the operation history and the reaction history (Step S212), and ends the initial operation determining process.

If the operation history and the reaction history are not present (NO in Step S211), the controller 17 determines, as a default initial operation (e.g., displaying a function selection menu), the initial operation to be performed when starting the cooperative operation with the mobile terminal M of the operator (Step S213), and ends the initial operation determining process.

Although the initial operation of the cooperative operation is determined based on the operation history and the reaction history in the initial operation determining process illustrated in FIG. 36, the initial operation may be determined in consideration of the preference information (e.g., the location where the passenger frequents, a favorite music genre, a favorite artist, and a favorite broadcaster) of the operator if the preference information is registered in the passenger information storage 12.

Referring back to FIG. 34, after the initial operation determining process (Step S210) ends, the controller 17 performs a cooperative operation with the mobile terminal M of the operator (Step S109). The initial operation to be performed when starting this cooperative operation is the one determined in the initial operation determining process. Furthermore, the configuration information for each passenger which is stored in the passenger information storage 12 is reflected in the cooperative operation.

During the cooperative operation with the mobile terminal M (NO in Step S110), the operation screen of the mobile app running on the mobile terminal M is displayed on the screen 21a. The operator can operate the mobile app in the similar sense as operating the in-vehicle app by operating the operation screen.

When the cooperative operation with the mobile terminal M ends (YES in Step S110), the history updating process in FIG. 37 is performed (Step S220). In the history updating process, first, the controller 17 checks whether the owner of the mobile terminal M which has cooperated in Step S109 is a registered passenger (Step S221).

If the owner of the cooperating mobile terminal M is a registered passenger (YES in Step S221), the controller 17 updates the operation history of the mobile terminal M which is stored in the mobile terminal information storage 13, based on the operation history of the mobile terminal M during the cooperative operation (Step S222).

Furthermore, the controller 17 updates the reaction history of the passenger as the operator which is stored in the passenger information storage 12, based on the reaction of the operator (the owner of the mobile terminal M) when starting the cooperation (Step S223).

If the owner of the cooperating mobile terminal M is not a registered passenger (NO in Step S221), that is, if the owner of the cooperating mobile terminal M is a guest passenger, the controller 17 updates the operation history of the mobile terminal M of the guest passenger, based on the operation history of the mobile terminal M during the cooperative operation (Step S224). Furthermore, the controller 17 updates the reaction history of the guest passenger, based on the reaction of the guest passenger when starting the cooperation (Step S225). When the guest passenger is subsequently registered in the in-vehicle information apparatus 10, the operation history of the mobile terminal M of the guest passenger and the reaction history of the guest passenger are stored in the passenger information storage 12 and the mobile terminal information storage 13 as information on the guest passenger.

Referring back to FIG. 34, after the history updating process (Step S220) ends, the processes return to Step S102.

Although the in-vehicle information apparatus 10 according to Embodiment 5 can use the personal information of the owner of the mobile terminal M which is stored in the passenger information storage 12 when cooperating with the mobile terminal M, the in-vehicle information apparatus 10 can perform operations highly customized to the preference of the owner of the mobile terminal M. Since the passenger authenticator 19 performs personal authentication of the passenger, it is possible to prevent the in-vehicle information apparatus 10 from using the personal information other than that of the owner of the cooperating mobile terminal M, thus obtaining high security.

[Modifications]

Although the in-vehicle information apparatus 10 according to Embodiment 5 configures an unregistered passenger as a guest passenger and allows the cooperation with the mobile terminal M of the unregistered passenger, the cooperation with the mobile terminal M of the unregistered passenger may be prohibited.

Furthermore, security may be further improved by disallowing an unregistered occupant from driving or boarding the vehicle. A technology for storing data of an electronic key of a vehicle in a mobile terminal is known. When a mobile terminal of an unregistered passenger stores data of the electronic key which is received from the owner who is authorized to use the vehicle, the passenger may be allowed to drive or board the vehicle.

[In-Vehicle Agent]

Hereinafter, an example of a voice agent (hereinafter referred to as an “in-vehicle agent”) that can register a passenger in a dialogue to facilitate the registration of the passenger into the in-vehicle information apparatus 10 (the process in Step S205 in FIG. 35) will be described.

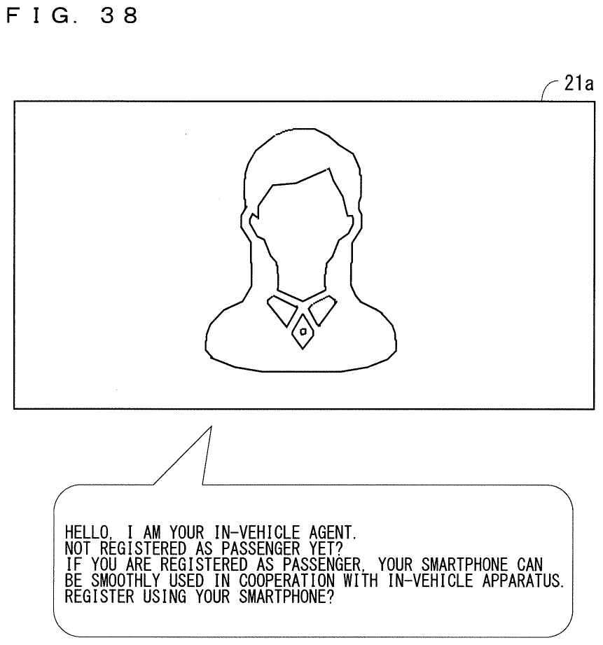

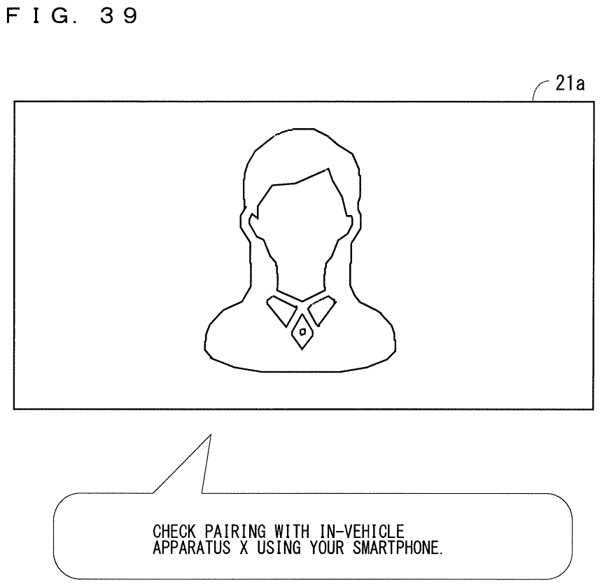

For example, if an unregistered passenger is detected in Step S202 in the authentication/registration process in FIG. 35 and Step S202 proceeds to Step S203, the controller 17 displays an execution screen of an in-vehicle agent on the screen 21a, and outputs, through a speaker that is not illustrated, an audio message inquiring whether to register an unregistered passenger who owns the mobile terminal M (a smartphone) in the in-vehicle information apparatus 10 as illustrated in FIG. 38.

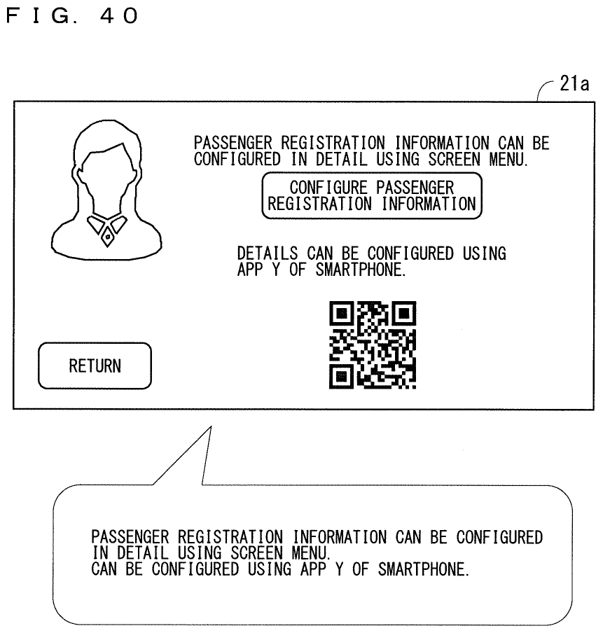

If the current passenger verbally responds that he/she wishes the registration, the processes proceed to Step S205 in FIG. 35, and the controller 17 outputs an audio message encouraging connecting (pairing) the mobile terminal M of the passenger to the in-vehicle information apparatus 10 as illustrated in FIG. 39. Upon confirming the connection of the mobile terminal M of the passenger to the in-vehicle information apparatus 10, the controller 17 guides a method for configuring the passenger information to be registered in the in-vehicle information apparatus 10 as illustrated in FIG. 40.

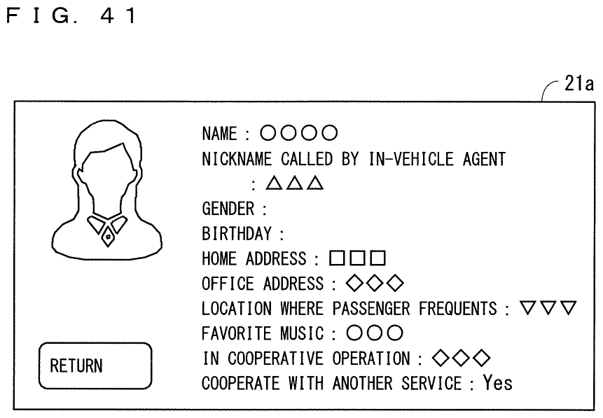

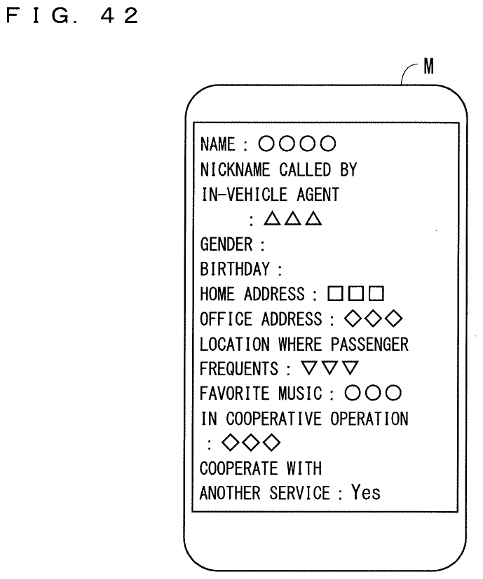

For example, if the passenger operates a “CONFIGURE PASSENGER REGISTRATION INFORMATION” button in FIG. 40, an input screen for the passenger information as illustrated in FIG. 41 is displayed. Consequently, the passenger can register, in the passenger information storage 12, the passenger information entered on the input screen. For another example, if the passenger causes the mobile terminal M to read the QR code (registered trademark) displayed in FIG. 40, an input app for the passenger information as illustrated in FIG. 42 is launched on the mobile terminal M. The passenger enters the passenger information on an input screen of this input app to transfer the passenger information to the in-vehicle information apparatus 10, so that the passenger information entered on the input screen can be registered in the passenger information storage 12.

The input screens illustrated in FIGS. 40 and 42 are configured to allow input of the name of the passenger, a nickname that the passenger wants the in-vehicle agent to call, the gender, the age, the birthday, and the home and office addresses of the passenger, the preference information of the passenger (e.g., the location where the passenger frequents, a favorite music genre, a favorite artist, and a favorite broadcaster), configuration of the function selection menu when starting the cooperative operation with the mobile terminal, and whether to cooperate with another cloud service. The passenger information that can be registered in the in-vehicle information apparatus 10 is not limited to these, but many more information may be registerable therein.

Furthermore, a registered passenger may be allowed to launch the input screen of FIG. 41 or the input app in FIG. 42, so that the input screen or the input app may be used for editing the registered personal information. Even while the mobile terminal M is not connected to the in-vehicle information apparatus 10, the user of the mobile terminal M may be allowed to launch the input app, so that the passenger information can be edited. The passenger information entered in the input app while the mobile terminal M is not connected to the in-vehicle information apparatus 10 may be transferred to the in-vehicle information apparatus 10 and updated automatically next time the mobile terminal M is connected to the in-vehicle information apparatus 10.

Embodiments according to the present invention can be freely combined or appropriately modified and omitted within the scope of the invention.

Although this invention has been described in detail, the description is in all aspects illustrative and does not restrict the invention. Therefore, numerous modifications and variations that have not yet been exemplified will be devised without departing from the scope of Embodiments.

### EXPLANATION OF REFERENCE SIGNS

M mobile terminal, 10 in-vehicle information apparatus, 11 communication unit, 12 passenger information storage, 13 mobile terminal information storage, 14 operation detector, 15 preliminary operation detector, 16 operator identifier, 17 controller, 18 passenger position determining unit, 19 passenger authenticator, 21 display, 21a screen, 22 sensor, 23 in-vehicle camera, 24 in-vehicle microphone, 25 authentication data obtaining device, 50 processing circuit, 51 processor, 52 memory, 60 passenger's finger, 101A to 101C cooperation start icon.

1. An in-vehicle information apparatus, comprising:
communication circuitry to communicate for performing a cooperative operation with a mobile terminal;
a passenger information storage in which passenger information is stored, the passenger information being information that can identify a passenger of a vehicle and including information on a seat position of the passenger in the vehicle and personal information of the passenger;
a mobile terminal information storage in which mobile terminal information is stored, the mobile terminal information including information in which the passenger of the vehicle is associated with the mobile terminal of the passenger;
a passenger authenticator to perform personal authentication of the passenger in the vehicle using the personal information;
an operation detector to detect an operation performed by the passenger of the vehicle on a screen of a display, the screen being installed in the vehicle;
a preliminary operation detector to detect a preliminary operation of the operation performed by the passenger of the vehicle on the screen;
an operator identifier to identify, as an operator based on the passenger information, the passenger who has performed the preliminary operation, and identify the seat position of the operator based on the passenger information; and
a controller to identify the mobile terminal of the operator based on the mobile terminal information when the operator is identified, display, on the screen, a cooperation start icon corresponding to the mobile terminal of the operator, and start the cooperative operation with the mobile terminal of the operator when an operation performed by the operator on the cooperation start icon is detected.

2. (canceled)

3. The in-vehicle information apparatus according to claim 1,
wherein the passenger information includes biological information of the passenger.

4. The in-vehicle information apparatus according to claim 1,
wherein the controller displays, on the screen, a cooperation start icon corresponding to a co-operable mobile terminal when the operator identifier cannot identify the operator, and starts the cooperative operation with one of the mobile terminals corresponding to a cooperation start icon operated by the passenger.

5. The in-vehicle information apparatus according to claim 1,
wherein the controller displays, on the screen together with the cooperation start icon corresponding to the mobile terminal of the operator, a cooperation start icon corresponding to another co-operable mobile terminal in a different form from a form of the cooperation start icon corresponding to the mobile terminal of the operator, and starts the cooperative operation with one of the mobile terminals corresponding to a cooperation start icon operated by the passenger.

6. The in-vehicle information apparatus according to claim 1,
wherein the operation detector detects a touch operation corresponding to the cooperation start icon displayed on the screen.

7. The in-vehicle information apparatus according to claim 6,
wherein the operation detector detects a distance between an indicator and the cooperation start icon displayed on the screen, and determines that the touch operation has been performed when the distance is smaller than or equal to a certain value.

8. The in-vehicle information apparatus according to claim 6,
wherein the operation detector detects movement of an indicator, and regards that the touch operation has been performed when detecting that the indicator is moving toward the cooperation start icon.

9. The in-vehicle information apparatus according to claim 1,
wherein the operation detector detects an air gesture operation on the cooperation start icon displayed on the screen.

10. The in-vehicle information apparatus according to claim 1,
wherein the controller displays, on the screen, a function selection menu of the mobile terminal of the operator when the operation performed by the operator on the cooperation start icon is detected, and displays, on the screen, a detailed menu of a selected function when a selecting operation performed by the operator on the function selection menu is detected.

11. The in-vehicle information apparatus according to claim 1,
wherein the controller displays, on the screen, the cooperation start icon including a function selection menu of the mobile terminal of the operator when the operator identifier identifies the operator, and displays, on the screen, a detailed menu of a selected function when a selecting operation performed by the operator on the function selection menu is detected.

12. The in-vehicle information apparatus according to claim 1,
wherein the controller changes a form of the cooperation start icon, depending on whether the operator is a driver of the vehicle.

13. The in-vehicle information apparatus according to claim 1,
wherein the controller changes a form of an icon to be displayed on the screen during the cooperative operation with the mobile terminal of the operator, depending on whether the operator is a driver of the vehicle.

14. The in-vehicle information apparatus according to claim 1,
wherein the mobile terminal information includes an operation history of the mobile terminal in a past cooperative operation, and
the controller determines an initial operation to be performed when starting the cooperative operation with the mobile terminal of the operator, based on the operation history of the mobile terminal of the operator.

15. (canceled)

16. The in-vehicle information apparatus according to claim 1,
wherein the passenger information includes configuration information for each passenger which is associated with an operation of the in-vehicle information apparatus.

17. The in-vehicle information apparatus according to claim 16,
wherein the configuration information is editable using the mobile terminal of the passenger accepted by the personal authentication.

18. The in-vehicle information apparatus according to claim 16,
wherein the configuration information includes preference information indicating preference of the passenger, and
the controller determines an initial operation to be performed when starting the cooperative operation with the mobile terminal of the operator, based on the preference information of the operator.

19. The in-vehicle information apparatus according to claim 1,
wherein the mobile terminal information includes an operation history of the mobile terminal in a past cooperative operation,
the passenger information includes a reaction history of the passenger who has reacted as the operator to an initial operation in the past cooperative operation, and
the controller determines an initial operation to be performed when starting the cooperative operation with the mobile terminal of the operator, based on the operation history of the mobile terminal of the operator and the reaction history of the operator.

20. The in-vehicle information apparatus according to claim 1,
wherein a service provider of the vehicle configures a type of the personal information that the passenger authenticator uses for performing personal authentication.

21. A method for an in-vehicle information apparatus to cooperate with a mobile terminal, the method comprising:
performing personal authentication of a passenger in a vehicle, the authentication being performed by a passenger authenticator of the in-vehicle information apparatus;
detecting a preliminary operation of an operation performed by the passenger of the vehicle on a screen of a display, the screen being installed in the vehicle, the detecting being performed by a preliminary operation detector of the in-vehicle information apparatus;
identifying, as an operator, the passenger who has performed the preliminary operation and identifying a seat position of the operator, the identifying being performed by an operator identifier of the in-vehicle information apparatus;
identifying a mobile terminal of the operator, and displaying, on the screen, a cooperation start icon corresponding to the mobile terminal of the operator, the identifying and the displaying being performed by a controller of the in-vehicle information apparatus;
detecting an operation performed by the operator on the cooperation start icon, the detecting being performed by an operation detector of the in-vehicle information apparatus; and
starting a cooperative operation with the mobile terminal of the operator when the operation performed by the operator on the cooperation start icon is detected, the starting being performed by the controller.
